(19) United States
(12) Patent Application Publication
(10) Pub. No.: US 2026/0280743 A1
(43) Pub. Date: Sep. 17, 2026

(54) Sequence Sending Method and Communication Apparatus

(71) Applicant: HUAWEI TECHNOLOGIES CO., LTD., Shenzhen (CN)

(72) Inventors: Yuanzhou Hu, Shanghai (CN); Potipak MIKHAIL, Moscow (RU); Fan Wang, Shanghai (CN)

(73) Assignee: HUAWEI TECHNOLOGIES CO., LTD., Shenzhen (CN)

(21) Appl. No.: 19/674,838

(22) Filed: May 12, 2026

Related U.S. Application Data
(63) Continuation of application No. PCT/CN2024/099575, filed on Jun. 17, 2024.

(30) Foreign Application Priority Data
Nov. 13, 2023 (RU) RU2023129272

(51) Int. Cl. H04J 13/00; H04L 27/26

(52) U.S. Cl. CPC H04J 13/0014; H04L 27/2605

(57) ABSTRACT

A method includes determining a first zero padding and N first sequences, where N is a positive integer greater than 1, and the N first sequences are determined based on a Golay complementary pair; sending the N first sequences in at least one first time unit, where a front of a 1^{st} first time unit in the at least one first time unit includes the first zero padding; determining a second zero padding and N second sequences, the N second sequences are determined based on a Golay complementary pair, and a length of the first zero padding is different from a length of the second zero padding; and sending the N second sequences in at least one second time unit, where a front of a 1^{st} second time unit in the at least one second time unit includes the second zero padding.

### CROSS-REFERENCE TO RELATED APPLICATIONS

This is a continuation of International Patent Application No. PCT/CN2024/099575 filed on Jun. 17, 2024, which claims priority to Russian Patent Application No. 2023129272 filed on Nov. 13, 2023. The disclosures of the aforementioned applications are hereby incorporated by reference in their entireties.

### TECHNICAL FIELD

This disclosure relates to the communication field, and more specifically, to a sequence sending method and a communication apparatus.

### BACKGROUND

In sensing and radar systems, in addition to a location of a moving target (which may be understood as a receiving apparatus or a sensing target), a velocity (or Doppler) of the moving target also may need to be measured. In one approach, a sending apparatus sends multiple sequences (sequence train) and receives signals reflected by a moving target, and the sending apparatus performs detection based on the received signals. The sending apparatus may calculate an ambiguity function of the received signals, and detect a location and a velocity of the target from the ambiguity function. A desirable ambiguity function is obtained by designing the multiple sent sequences. The ambiguity function may be a two-dimensional delay-Doppler ambiguity function. Designing the multiple sent sequences may cause the ambiguity function to generate a low ambiguity zone in which values of the ambiguity function are very low, or in other words, sidelobe leakage is very low. Therefore, the sending apparatus can detect the location and the velocity of the moving target more accurately based on the signals reflected by the moving target.

In some scenarios, when multiple moving targets may need to be detected at the same time, if the multiple detected moving targets are all located within a low ambiguity zone, the multiple moving targets can also be identified, and a location and a velocity are detected for each moving target. However, detecting multiple moving targets at the same time may cause mutual interference, resulting in inaccurate detection of each moving target.

Therefore, how to mitigate mutual interference between multiple moving objects and improve detection accuracy for each moving object becomes an urgent technical problem to be resolved.

### SUMMARY

This disclosure provides a sequence sending method. When multiple moving targets may need to be detected at the same time, the method can mitigate mutual interference between the multiple moving targets, improving detection accuracy of each moving target.

According to a first aspect, a sequence sending method is provided. The method may be performed by a network device or a terminal device, may be performed by a component of the network device or the terminal device, for example, a processor, a chip, or a chip system of the network device or the terminal device, or may be implemented by a logical module or software that can implement all or some functions of the network device or the terminal device.

The method includes: determining a first zero padding and N first sequences, where N is a positive integer greater than 1, and the N first sequences are determined based on a Golay complementary pair (GCP); sending the N first sequences in at least one first time unit, where a front of a 1^{st} first time unit in the at least one first time unit includes the first zero padding; determining a second zero padding and N second sequences, where the N second sequences are determined based on a GCP, and a length of the first zero padding is different from a length of the second zero padding; and sending the N second sequences in at least one second time unit, where a front of a 1^{st} second time unit in the at least one second time unit includes the second zero padding.

In the foregoing technical solution, two sequences of a GCP have a property of ideal aperiodic correlation. When a target is sensed by using multiple sequences generated based on the GCP sequence, for example, by calculating an ambiguity function, a length of a zero padding (that is, the length of a first ZP) at a front of the sequences is related to a peak position of the target determined in the ambiguity function. When multiple sequences are sent by using different zero padding lengths, a same detection target has different peak positions in the ambiguity function, and maintenance of the property of ideal aperiodic correlation can still be assumed in a low-velocity regime. Therefore, values of multiple possible zero padding lengths are designed, so that multiple targets can be detected, peak positions corresponding to the multiple detected targets are more easily distinguished, and interference between the multiple detected targets is mitigated.

With reference to the first aspect, in some implementations of the first aspect, an end of each of the at least one first time unit includes a third zero padding, and the third zero padding is used to separate the at least one first time unit.

With reference to the first aspect, in some implementations of the first aspect, an end of a last first time unit in the at least one first time unit includes a fourth zero padding, and a length of the fourth zero padding is related to the length of the first zero padding.

In the foregoing technical solution, when the N first sequences are sent in multiple consecutive first time units and the N second sequences are sent in multiple consecutive second time units, because the length of the first zero padding is different from the length of the second zero padding, duration of sending the N first sequences is different from duration of sending the N second sequences. In this case, the fourth ZP is introduced, and the length of the fourth ZP is related to the length of the first ZP, so that for different lengths of the first ZP, adjustment may be made to cause the duration of sending the N first sequences to equal the duration of sending the N second sequences, and the N first sequences and the N second sequences may be sent in same duration, simplifying a time domain structure of a sent sequence and avoiding interference with a signal of another type.

With reference to the first aspect, in some implementations of the first aspect, a front of each of the at least one first time unit includes the first zero padding.

With reference to the first aspect, in some implementations of the first aspect, an end of each of the at least one first time unit includes a fourth zero padding, and a length of the fourth zero padding is related to the length of the first zero padding.

With reference to the first aspect, in some implementations of the first aspect, an end of each of the at least one second time unit includes a fifth zero padding, and the fifth zero padding is used to separate the at least one second time unit.

With reference to the first aspect, in some implementations of the first aspect, an end of a last second time unit in the at least one second time unit includes a sixth zero padding, and a length of the sixth zero padding is related to the length of the second zero padding.

With reference to the first aspect, in some implementations of the first aspect, a front of each of the at least one second time unit includes the second zero padding.

With reference to the first aspect, in some implementations of the first aspect, an end of each of the at least one second time unit includes a sixth zero padding, and a length of the sixth zero padding is related to the length of the second zero padding.

In the foregoing technical solution, when the N first sequences are sent in multiple consecutive second time units and the N second sequences are sent in multiple consecutive second time units, because the length of the first zero padding is different from the length of the second zero padding, duration of sending the N first sequences is different from duration of sending the N second sequences. In this case, the sixth ZP is introduced, and the length of the sixth ZP is related to the length of the second ZP, so that for different lengths of the first ZP, adjustment may be made to cause the duration of sending the N first sequences to equal the duration of sending the N second sequences, and the N first sequences and the N second sequences may be sent in same duration, simplifying a time domain structure of a sent sequence and avoiding interference with a signal of another type.

With reference to the first aspect, in some implementations of the first aspect, a sum of the length of the first zero padding and the length of the fourth zero padding is the same as a sum of the length of the second zero padding and the length of the sixth zero padding.

With reference to the first aspect, in some implementations of the first aspect, the N first sequences are obtained by performing phase rotation on each of N third sequences based on a first phase factor, the N third sequences are in one-to-one correspondence with the N first sequences, a value of the first phase factor is related to the N third sequences, the N second sequences are obtained by performing phase rotation on each of N fourth sequences based on a second phase factor, the N fourth sequences are in one-to-one correspondence with the N second sequences, a value of the second phase factor is related to the N fourth sequences, the first phase factor is different from the second phase factor, the N third sequences are determined based on a GCP, and the N fourth sequences are determined based on a GCP.

With reference to the first aspect, in some implementations of the first aspect, the method further includes: performing phase rotation on each of N third sequences based on a first phase factor to obtain the N first sequences, where the N third sequences are in one-to-one correspondence with the N first sequences, and a value of the first phase factor is related to the N third sequences; and performing phase rotation on each of N fourth sequences based on a second phase factor to obtain the N second sequences, where the N fourth sequences are in one-to-one correspondence with the N second sequences, a value of the second phase factor is related to the N fourth sequences, and the first phase factor is different from the second phase factor.

With reference to the first aspect, in some implementations of the first aspect, an n^{th} first sequence in the N first sequences is obtained by performing phase rotation on an n^{th} third sequence based on a phase value of the n^{th} third sequence, the phase value of the n^{th} third sequence is determined based on the first phase factor, and the phase value of the n^{th} third sequence is related to an index of a first time unit in which the n^{th} third sequence is located.

With reference to the first aspect, in some implementations of the first aspect, the method further includes: performing phase rotation on an n^{th} third sequence based on a phase value of the n^{th} third sequence to obtain an n^{th} first sequence in the N first sequences, where the phase value of the n^{th} third sequence is determined based on the first phase factor, and the phase value of the n^{th} third sequence is related to an index of a first time unit in which the n^{th} third sequence is located.

With reference to the first aspect, in some implementations of the first aspect, each first time unit or second time unit includes at least one symbol, and the symbol includes any one of the following: a single-carrier symbol, an orthogonal frequency-division multiplexing (OFDM) symbol, or a single-carrier frequency-division multiple access (SC-FDMA) symbol.

With reference to the first aspect, in some implementations of the first aspect, each first time unit or second time unit includes at least one symbol, each symbol in the first time unit is generated based on at least one first sequence, and each symbol in the second time unit is generated based on at least one second sequence.

With reference to the first aspect, in some implementations of the first aspect, at least one first sequence is sent in each of the at least one first time unit, and data of the at least one symbol included in each first time unit is generated based on the at least one first sequence corresponding to the first time unit.

With reference to the first aspect, in some implementations of the first aspect, at least one second sequence is sent in each of the at least one second time unit, and data of the at least one symbol included in each second time unit is generated based on the at least one second sequence corresponding to the second time unit.

According to a second aspect, a sequence sending method is provided. The method may be performed by a network device or a terminal device, may be performed by a component of the network device or the terminal device, for example, a processor, a chip, or a chip system of the network device or the terminal device, or may be implemented by a logical module or software that can implement all or some functions of the network device or the terminal device.

The method includes: performing phase rotation on each of N third sequences based on a first phase factor to obtain N first sequences, where N is a positive integer greater than 1, the N third sequences are in one-to-one correspondence with the N first sequences, and a value of the first phase factor is related to the N third sequences; sending the N first sequences in at least one first time unit; performing phase rotation on each of N fourth sequences based on a second phase factor to obtain N second sequences, where the N fourth sequences are in one-to-one correspondence with the N second sequences, a value of the second phase factor is related to the N fourth sequences, and the first phase factor is different from the second phase factor; and sending the N second sequences in at least one second time unit, where the N third sequences are determined based on a GCP, and the N fourth sequences are determined based on a GCP.

With reference to the second aspect, in some implementations of the second aspect, an n^{th} first sequence in the N first sequences is obtained by performing phase rotation on an n^{th} third sequence based on a phase value of the n^{th} third sequence, the phase value of the n^{th} third sequence is determined based on the first phase factor, and the phase value of the n^{th} third sequence is related to an index of a first time unit in which the n^{th} third sequence is located.

With reference to the second aspect, in some implementations of the second aspect, the method further includes: performing phase rotation on an n^{th} third sequence based on a phase value of the n^{th} third sequence to obtain an n^{th} first sequence in the N first sequences, where the phase value of the n^{th} third sequence is determined based on the first phase factor, and the phase value of the n^{th} third sequence is related to an index of a first time unit in which the n^{th} third sequence is located.

With reference to the second aspect, in some implementations of the second aspect, a front of a 1^{st} first time unit in the at least one first time unit includes a first zero padding.

With reference to the second aspect, in some implementations of the second aspect, an end of each of the at least one first time unit includes a third zero padding, and the third zero padding is used to separate the at least one first time unit.

With reference to the second aspect, in some implementations of the second aspect, an end of a last first time unit in the at least one first time unit includes a fourth zero padding, and a length of the fourth zero padding is related to a length of the first zero padding.

With reference to the second aspect, in some implementations of the second aspect, a front of each of the at least one first time unit includes the first zero padding.

With reference to the second aspect, in some implementations of the second aspect, an end of each of the at least one first time unit includes a fourth zero padding, and a length of the fourth zero padding is related to a length of the first zero padding.

With reference to the second aspect, in some implementations of the second aspect, a front of a 1^{st} second time unit in the at least one second time unit includes a second zero padding, and a length of the second zero padding is different from the length of the first zero padding.

With reference to the second aspect, in some implementations of the second aspect, an end of each of the at least one second time unit includes a fifth zero padding, and the fifth zero padding is used to separate the at least one second time unit.

With reference to the second aspect, in some implementations of the second aspect, an end of a last second time unit in the at least one second time unit includes a sixth zero padding, and a length of the sixth zero padding is related to the length of the second zero padding.

With reference to the second aspect, in some implementations of the second aspect, a front of each of the at least one second time unit includes the second zero padding.

With reference to the second aspect, in some implementations of the second aspect, an end of each of the at least one second time unit includes a sixth zero padding, and a length of the sixth zero padding is related to the length of the second zero padding.

With reference to the second aspect, in some implementations of the second aspect, a front of each of the at least one first time unit includes a first cyclic prefix, and each of the at least one second time unit includes a second cyclic prefix.

With reference to the second aspect, in some implementations of the second aspect, each of the N first sequences is obtained by performing cyclic shift on each of N fifth sequences based on a value of a first cyclic shift, the value of the first cyclic shift is related to the N fifth sequences, the N second sequences are obtained by performing cyclic shift on each of N sixth sequences based on a value of a second cyclic shift, the value of the second cyclic shift is related to the N sixth sequences, and the value of the second cyclic shift is different from the value of the first cyclic shift.

With reference to the second aspect, in some implementations of the second aspect, the method further includes: performing cyclic shift on each of N fifth sequences based on a value of a first cyclic shift to obtain the N first sequences, where the value of the first cyclic shift is related to the N fifth sequences, and performing cyclic shift on each of N sixth sequences based on a value of a second cyclic shift to obtain the N second sequences, where the value of the second cyclic shift is related to the N sixth sequences, and the value of the second cyclic shift is different from the value of the first cyclic shift.

With reference to the second aspect, in some implementations of the second aspect, each first time unit or second time unit includes at least one symbol, and the symbol includes any one of the following: a single-carrier symbol, an OFDM symbol, or an SC-FDMA symbol.

With reference to the second aspect, in some implementations of the second aspect, each first time unit or second time unit includes at least one symbol, each symbol in the first time unit is generated based on at least one first sequence, and each symbol in the second time unit is generated based on at least one second sequence.

With reference to the second aspect, in some implementations of the second aspect, at least one first sequence is sent in each of the at least one first time unit, and data of the at least one symbol included in each first time unit is generated based on the at least one first sequence corresponding to the first time unit.

With reference to the second aspect, in some implementations of the second aspect, at least one second sequence is sent in each of the at least one second time unit, and data of the at least one symbol included in each second time unit is generated based on the at least one second sequence corresponding to the second time unit.

According to a third aspect, a sequence sending apparatus is provided, including a processing module and a sending module. The processing module is configured to determine a first zero padding and N first sequences, where N is a positive integer greater than 1, and the N first sequences are determined based on a GCP. The sending module is configured to send the N first sequences in at least one first time unit, where a front of a 1^{st} first time unit in the at least one first time unit includes the first zero padding. The processing module is further configured to determine a second zero padding and N second sequences, where the N second sequences are determined based on a GCP, and a length of the first zero padding is different from a length of the second zero padding. The sending module is configured to send the N second sequences in at least one second time unit, where a front of a 1^{st} second time unit in the at least one second time unit includes the second zero padding.

With reference to the third aspect, in some implementations of the third aspect, an end of each of the at least one first time unit includes a third zero padding, and the third zero padding is used to separate the at least one first time unit.

With reference to the third aspect, in some implementations of the third aspect, an end of a last first time unit in the at least one first time unit includes a fourth zero padding, and a length of the fourth zero padding is related to the length of the first zero padding.

With reference to the third aspect, in some implementations of the third aspect, a front of each of the at least one first time unit includes the first zero padding.

With reference to the third aspect, in some implementations of the third aspect, an end of each of the at least one first time unit includes a fourth zero padding, and a length of the fourth zero padding is related to the length of the first zero padding.

With reference to the third aspect, in some implementations of the third aspect, an end of each of the at least one second time unit includes a fifth zero padding, and the fifth zero padding is used to separate the at least one second time unit.

With reference to the third aspect, in some implementations of the third aspect, an end of a last second time unit in the at least one second time unit includes a sixth zero padding, and a length of the sixth zero padding is related to the length of the second zero padding.

With reference to the third aspect, in some implementations of the third aspect, a front of each of the at least one second time unit includes the second zero padding.

With reference to the third aspect, in some implementations of the third aspect, an end of each of the at least one second time unit includes a sixth zero padding, and a length of the sixth zero padding is related to the length of the second zero padding.

With reference to the third aspect, in some implementations of the third aspect, a sum of the length of the first zero padding and the length of the fourth zero padding is the same as a sum of the length of the second zero padding and the length of the sixth zero padding.

With reference to the third aspect, in some implementations of the third aspect, the N first sequences are obtained by performing phase rotation on each of N third sequences based on a first phase factor, the N third sequences are in one-to-one correspondence with the N first sequences, a value of the first phase factor is related to the N third sequences, the N second sequences are obtained by performing phase rotation on each of N fourth sequences based on a second phase factor, the N fourth sequences are in one-to-one correspondence with the N second sequences, a value of the second phase factor is related to the N fourth sequences, the first phase factor is different from the second phase factor, the N third sequences are determined based on a GCP, and the N fourth sequences are determined based on a GCP.

With reference to the third aspect, in some implementations of the third aspect, the processing module is further configured to perform phase rotation on each of N third sequences based on a first phase factor to obtain the N first sequences, where the N third sequences are in one-to-one correspondence with the N first sequences, and a value of the first phase factor is related to the N third sequences. The processing module is further configured to perform phase rotation on each of N fourth sequences based on a second phase factor to obtain the N second sequences, where the N fourth sequences are in one-to-one correspondence with the N second sequences, a value of the second phase factor is related to the N fourth sequences, and the first phase factor is different from the second phase factor.

With reference to the third aspect, in some implementations of the third aspect, an n^{th} first sequence in the N first sequences is obtained by performing phase rotation on an n^{th} third sequence based on a phase value of the n^{th} third sequence, the phase value of the n^{th} third sequence is determined based on the first phase factor, and the phase value of the n^{th} third sequence is related to an index of a first time unit in which the n^{th} third sequence is located.

With reference to the third aspect, in some implementations of the third aspect, the processing module is further configured to perform phase rotation on an n^{th} third sequence based on a phase value of the n^{th} third sequence to obtain an n^{th} first sequence in the N first sequences, where the phase value of the n^{th} third sequence is determined based on the first phase factor, and the phase value of the n^{th} third sequence is related to an index of a first time unit in which the n^{th} third sequence is located.

With reference to the third aspect, in some implementations of the third aspect, each first time unit or second time unit includes at least one symbol, and the symbol includes any one of the following: a single-carrier symbol, an OFDM symbol, or an SC-FDMA symbol.

With reference to the third aspect, in some implementations of the third aspect, each first time unit or second time unit includes at least one symbol, each symbol in the first time unit is generated based on at least one first sequence, and each symbol in the second time unit is generated based on at least one second sequence.

With reference to the third aspect, in some implementations of the third aspect, at least one first sequence is sent in each of the at least one first time unit, and data of the at least one symbol included in each first time unit is generated based on the at least one first sequence corresponding to the first time unit.

With reference to the third aspect, in some implementations of the third aspect, at least one second sequence is sent in each of the at least one second time unit, and data of the at least one symbol included in each second time unit is generated based on the at least one second sequence corresponding to the second time unit.

According to a fourth aspect, a sequence sending apparatus is provided, including a processing module and a sending module. The processing module is configured to perform phase rotation on each of N third sequences based on a first phase factor to obtain N first sequences, where N is a positive integer greater than 1, the N third sequences are in one-to-one correspondence with the N first sequences, and a value of the first phase factor is related to the N third sequences. The sending module is configured to send the N first sequences in at least one first time unit. The processing module is further configured to perform phase rotation on each of N fourth sequences based on a second phase factor to obtain N second sequences, where the N fourth sequences are in one-to-one correspondence with the N second sequences, a value of the second phase factor is related to the N fourth sequences, and the first phase factor is different from the second phase factor. The sending module is further configured to send the N second sequences in at least one second time unit, where the N third sequences are determined based on a GCP, and the N fourth sequences are determined based on a GCP.

With reference to the fourth aspect, in some implementations of the fourth aspect, an n^{th} first sequence in the N first sequences is obtained by performing phase rotation on an n^{th} third sequence based on a phase value of the n^{th} third sequence, the phase value of the n^{th} third sequence is determined based on the first phase factor, and the phase value of the n^{th} third sequence is related to an index of a first time unit in which the n^{th} third sequence is located.

With reference to the fourth aspect, in some implementations of the fourth aspect, the processing module is further configured to perform phase rotation on an n^{th} third sequence based on a phase value of the n^{th} third sequence to obtain an n^{th} first sequence in the N first sequences, where the phase value of the n^{th} third sequence is determined based on the first phase factor, and the phase value of the n^{th} third sequence is related to an index of a first time unit in which the n^{th} third sequence is located.

With reference to the fourth aspect, in some implementations of the fourth aspect, a front of a 1^{st} first time unit in the at least one first time unit includes a first zero padding.

With reference to the fourth aspect, in some implementations of the fourth aspect, an end of each of the at least one first time unit includes a third zero padding, and the third zero padding is used to separate the at least one first time unit.

With reference to the fourth aspect, in some implementations of the fourth aspect, an end of a last first time unit in the at least one first time unit includes a fourth zero padding, and a length of the fourth zero padding is related to a length of the first zero padding.

With reference to the fourth aspect, in some implementations of the fourth aspect, a front of each of the at least one first time unit includes the first zero padding.

With reference to the fourth aspect, in some implementations of the fourth aspect, an end of each of the at least one first time unit includes a fourth zero padding, and a length of the fourth zero padding is related to a length of the first zero padding.

With reference to the fourth aspect, in some implementations of the fourth aspect, a front of a 1^{st} second time unit in the at least one second time unit includes a second zero padding, and a length of the second zero padding is different from the length of the first zero padding.

With reference to the fourth aspect, in some implementations of the fourth aspect, an end of each of the at least one second time unit includes a fifth zero padding, and the fifth zero padding is used to separate the at least one second time unit.

With reference to the fourth aspect, in some implementations of the fourth aspect, an end of a last second time unit in the at least one second time unit includes a sixth zero padding, and a length of the sixth zero padding is related to the length of the second zero padding.

With reference to the fourth aspect, in some implementations of the fourth aspect, a front of each of the at least one second time unit includes the second zero padding.

With reference to the fourth aspect, in some implementations of the fourth aspect, an end of each of the at least one second time unit includes a sixth zero padding, and a length of the sixth zero padding is related to the length of the second zero padding.

With reference to the fourth aspect, in some implementations of the fourth aspect, a front of each of the at least one first time unit includes a first cyclic prefix, and each of the at least one second time unit includes a second cyclic prefix.

With reference to the fourth aspect, in some implementations of the fourth aspect, each of the N first sequences is obtained by performing cyclic shift on each of N fifth sequences based on a value of a first cyclic shift, the value of the first cyclic shift is related to the N fifth sequences, the N second sequences are obtained by performing cyclic shift on each of N sixth sequences based on a value of a second cyclic shift, the value of the second cyclic shift is related to the N sixth sequences, and the value of the second cyclic shift is different from the value of the first cyclic shift.

With reference to the fourth aspect, in some implementations of the fourth aspect, the processing module is further configured to perform cyclic shift on each of N fifth sequences based on a value of a first cyclic shift to obtain the N first sequences, where the value of the first cyclic shift is related to the N fifth sequences, and perform cyclic shift on each of N sixth sequences based on a value of a second cyclic shift to obtain the N second sequences, where the value of the second cyclic shift is related to the N sixth sequences, and the value of the second cyclic shift is different from the value of the first cyclic shift.

With reference to the fourth aspect, in some implementations of the fourth aspect, each first time unit or second time unit includes at least one symbol, and the symbol includes any one of the following: a single-carrier symbol, an OFDM symbol, or an SC-FDMA symbol.

With reference to the fourth aspect, in some implementations of the fourth aspect, each first time unit or second time unit includes at least one symbol, each symbol in the first time unit is generated based on at least one first sequence, and each symbol in the second time unit is generated based on at least one second sequence.

With reference to the fourth aspect, in some implementations of the fourth aspect, at least one first sequence is sent in each of the at least one first time unit, and data of the at least one symbol included in each first time unit is generated based on the at least one first sequence corresponding to the first time unit.

With reference to the fourth aspect, in some implementations of the fourth aspect, at least one second sequence is sent in each of the at least one second time unit, and data of the at least one symbol included in each second time unit is generated based on the at least one second sequence corresponding to the second time unit.

According to a fifth aspect, a communication apparatus is provided, including at least one processor. The processor is configured to cause, by executing computer instructions stored in a memory or by using a logic circuit, the communication apparatus to perform the method according to any one of the foregoing aspects.

In some possible designs, the communication apparatus further includes a memory, configured to store computer instructions and/or a configuration file of the logic circuit. Optionally, the memory and the processor are integrated together, or the memory is independent of the processor.

According to a sixth aspect, a communication apparatus is provided, including a processor and a communication interface. The communication interface is configured to input and/or output a signal. The processor is configured to execute a computer program or instructions, to cause the communication apparatus to perform the method according to any one of the foregoing aspects.

In some possible designs, the communication interface is an interface circuit, and is configured to read and write computer instructions. For example, the interface circuit is configured to receive computer-executable instructions (where the computer-executable instructions are stored in the memory, and may be directly read from the memory, or may be read via another component), and transmit the computer-executable instructions to the processor.

In some possible designs, the communication interface is configured to communicate with a module other than the communication apparatus.

In some possible designs, the communication apparatus may be a chip or a chip system. When the apparatus is a chip system, the chip system may include a chip, or may include a chip and another discrete component.

According to a seventh aspect, a communication apparatus is provided, including a logic circuit and an interface circuit. The interface circuit is configured to input information and/or output information. The logic circuit is configured to perform the method according to any one of the foregoing aspects, and perform processing and/or generate the output information based on the input information.

According to an eighth aspect, a communication apparatus is provided. The communication apparatus may be a first communication apparatus, may be a module or unit (for example, a chip, a chip system, or a circuit) that is in the first communication apparatus and that is in one-to-one correspondence with the method/operation/step/action performed by the first communication apparatus as described in the first aspect, or may be a module or unit that can be used together with the first communication apparatus.

For example, the first communication apparatus may be a terminal device, a network device, or the like.

According to a ninth aspect, a communication apparatus is provided. The communication apparatus may be a second communication apparatus, may be a module or unit (for example, a chip, a chip system, or a circuit) that is in the second communication apparatus and that is in one-to-one correspondence with the method/operation/step/action performed by the second communication apparatus as described in the first aspect, or may be a module or unit that can be used together with the second communication apparatus.

For example, the second communication apparatus may be a terminal device, a network device, or the like.

According to a tenth aspect, a chip is provided. The chip includes a processor and a communication interface. The processor reads, through the communication interface, instructions stored in a memory, to perform the method provided in any one of the foregoing aspects or the implementations of the foregoing aspects. The communication interface may be implemented by hardware or software.

Optionally, in an implementation, the chip further includes a memory. The memory stores a computer program or instructions. The processor is configured to execute the computer program or the instructions stored in the memory. When the computer program or the instructions are executed, the processor is configured to perform the method provided in any one of the foregoing aspects or the implementations of the foregoing aspects.

When the method provided in this disclosure is performed by a chip, a quantity of chips that specifically implement the method in this disclosure is not limited in this disclosure. For example, the method may be performed by one chip, or may be performed by two or more chips. In addition, when the method in this disclosure is implemented by two or more chips, a chip vendor is not limited. The chips may be from a same vendor or from different vendors.

According to an eleventh aspect, a communication system is provided. The system includes at least two communication apparatuses, and the at least two communication apparatuses are configured to perform the method according to any one of the foregoing aspects.

Optionally, in an implementation, the at least two communication apparatuses include at least two network devices, or processors, chips, chip systems, or the like of at least two network devices.

Optionally, in an implementation, the at least two communication apparatuses include at least two terminal devices, or processors, chips, chip systems, or the like of at least two terminal devices.

According to a twelfth aspect, a computer-readable storage medium is provided. The computer-readable storage medium stores a computer program or instructions. When the computer program or the instructions are executed by a processor, the method according to any one of the foregoing aspects is performed.

According to a thirteenth aspect, a computer program product is provided. When the computer program product is executed by a processor, the method according to any one of the foregoing aspects is performed.

For technical effects brought by any design scheme from the third aspect to the thirteenth aspect, refer to technical effects brought by different design schemes from the first aspect or the second aspect. Details are not described herein again.

### BRIEF DESCRIPTION OF DRAWINGS

FIG. 1A and FIG. 1B are diagrams of aperiodic autocorrelation calculation;

FIG. 2 is a diagram of a structure of a communication system according to an embodiment of this disclosure;

FIG. 3 is a block diagram of a sequence sending method according to this disclosure;

FIG. 4 is a diagram of sending multiple sequences by a first communication apparatus and sending multiple sequences by a second communication apparatus according to this disclosure;

FIG. 5 is a diagram of including a third ZP at an end of each time unit according to this disclosure;

FIG. 6 is a diagram of including a fourth ZP at an end of a last time unit according to this disclosure;

FIG. 7A and FIG. 7B are a diagram of including a first ZP at a front of each time unit and including a fourth ZP at an end of each time unit according to this disclosure;

FIG. 8 is a block diagram of another sequence sending method according to this disclosure;

FIG. 9A and FIG. 9B are a diagram of phase values for performing phase rotation on sequences sent in consecutive time units according to this disclosure;

FIG. 10 is a diagram of phase values for performing phase rotation on sequences sent in inconsecutive time units according to this disclosure;

FIG. 11 is another diagram of phase values for performing phase rotation on sequences sent in inconsecutive time units according to this disclosure;

FIG. 12 is another diagram of phase values for performing phase rotation on sequences sent in inconsecutive time units according to this disclosure;

FIG. 13A and FIG. 13B are a diagram of cyclic shift values for performing cyclic shift on multiple sent sequences according to this disclosure;

FIG. 14 is a diagram of a structure of a communication apparatus 1400 according to this disclosure;

FIG. 15 is a diagram of a communication system according to this disclosure; and

FIG. 16 is a diagram of a structure of a communication device 1700 according to this disclosure.

### DESCRIPTION OF EMBODIMENTS

The following describes technical solutions of this disclosure with reference to accompanying drawings.

In descriptions of this disclosure, unless otherwise specified, “/” represents an “or” relationship between associated objects. For example, A/B may represent A or B. In this disclosure, “and/or” describes only an association relationship between associated objects, and represents that three relationships may exist. For example, A and/or B may represent the following three cases: Only A exists, both A and B exist, and only B exists, where A and B may be singular or plural.

In addition, in the descriptions of this disclosure, “multiple” means two or more than two unless otherwise specified. “At least one of the following items (pieces)” or a similar expression thereof indicates any combination of these items, including a singular item (piece) or any combination of plural items (pieces). For example, at least one item (piece) of a, b, or c may indicate: a, b, c, a and b, a and c, b and c, or a, b, and c, where a, b, and c may be singular or plural.

In addition, to clearly describe the technical solutions in embodiments of this disclosure, terms such as “first” and “second” are used in embodiments of this disclosure to distinguish between same items or similar items that provide basically same functions or purposes. A person skilled in the art may understand that the terms such as “first” and “second” do not limit a quantity or an execution sequence, and the terms such as “first” and “second” do not indicate a definite difference.

In addition, in embodiments of this disclosure, the word “example” or “for example” is used to represent giving an example, an illustration, or a description. Any embodiment or design scheme described as an “example” or “for example” in embodiments of this disclosure should not be explained as being more preferred or having more advantages than another embodiment or design scheme. Exactly, use of the terms such as “example” or “for example” is intended to present a related concept in a specific manner for ease of understanding.

It may be understood that an “embodiment” used throughout this specification means that particular features, structures, or characteristics related to this embodiment are included in at least one embodiment of this disclosure. Therefore, embodiments in the entire specification are not necessarily a same embodiment. In addition, these particular features, structures, or characteristics may be combined in one or more embodiments in any appropriate manner. It may be understood that sequence numbers of the processes do not mean execution sequences in various embodiments of this disclosure. The execution sequences of the processes should be determined based on functions and internal logic of the processes, and should not be construed as any limitation on implementation processes of embodiments of this disclosure.

It may be understood that in some scenarios, some optional features in embodiments of this disclosure may be independently implemented without depending on another feature, for example, a solution on which the optional features are currently based, to resolve a corresponding technical problem and achieve corresponding effects. Alternatively, in some scenarios, the optional features may be combined with other features based on a requirement. Correspondingly, the apparatus provided in embodiments of this disclosure may also correspondingly implement these features or functions. Details are not described herein.

In this disclosure, unless otherwise specified, mutual reference may be made between same or similar parts of embodiments. In various embodiments of this disclosure, unless otherwise specified or there is a logic conflict, terms and/or descriptions in different embodiments are consistent and may be referenced by each other. Technical features in different embodiments may be combined to form a new embodiment based on an internal logical relationship. The following implementations of this disclosure are not intended to limit the protection scope of this disclosure.

For ease of understanding of the technical solutions in embodiments of this disclosure, the following first briefly describes technologies related to this disclosure.

(1) Correlation operation: The correlation operation is a processing process performed between two sequences, and includes multiplication and addition operations performed between different elements in the two sequences. The correlation operation may include a periodic correlation operation or an aperiodic correlation operation.

(2) Autocorrelation: If two sequences are the same, a correlation operation performed between the two sequences is referred to as an autocorrelation (or an autocorrelation operation).

(3) Cross-correlation: If two sequences are different, a correlation operation performed between the two sequences is referred to as a cross-correlation (or a cross-correlation operation).

(4) Aperiodic autocorrelation: When a sequence autocorrelation is calculated, a correlation value of overlapping elements of two sequences is calculated by using a relative displacement between the sequences.

If a sequence length is L, there may be 2L−1 cases of relative displacement values between the sequences: −L+1, −L+2, . . . , −1, 0, 1, . . . , L−2, and L−1. Therefore, there are 2L−1 results in total for an aperiodic autocorrelation operation, where L is an integer greater than 1.

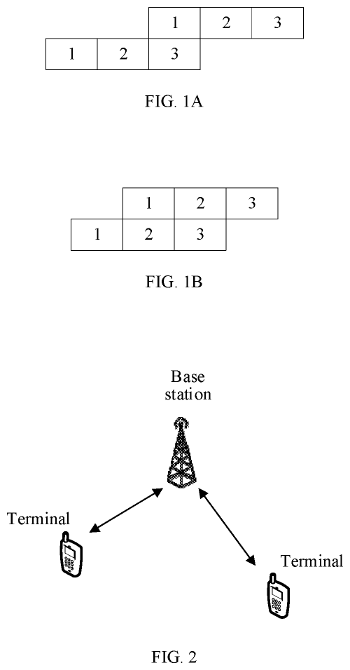

For example, for sequences [1, 2, 3], when a relative displacement value between the sequences is −2, a status of a relative position between the sequences may be shown in FIG. 1A. In this case, an aperiodic autocorrelation result is 1×3=3. When a relative displacement value between the sequences is −1, a status of a relative position between the sequences may be shown in FIG. 1B. In this case, an aperiodic autocorrelation result is 1×2+2×3=8. By analogy, when a relative displacement value between the sequences is sequentially −2, −1, 0, 1, and 2, an aperiodic autocorrelation result of the sequences is sequentially 3, 8, 14, 8, and 3.

Optionally, there may be L cases of relative displacement values in the aperiodic autocorrelation operation: 0, 1, . . . , L−2, and L−1. For example, when an aperiodic autocorrelation operation is performed on a sequence q₁ whose length is L, a k^{th} value obtained based on the aperiodic autocorrelation operation (or a value obtained when a relative shift value is k) may be represented as:

$${\sum }_{i = 0}^{L - k - 1} {q}_{1} ( i ) {q}_{1} ( i + k ) ,$$

k=0, 1, . . . , L−1.

It may be understood that a processing process of an aperiodic cross-correlation operation is similar to that of the aperiodic autocorrelation operation.

### (5) Golay Complementary Pair (GCP)

The GCP, also known as a Golay complementary pair, Golay complementary sequences, or GCP sequences, is a type of perfect aperiodic autocorrelation sequences. GCP is defined as that, for a pair of sequences x and y with a code length of L, if a sum of their aperiodic autocorrelation functions (AACF) is 0 at other displacements other than at a zero displacement, the two sequences are a GCP. For the sequence x=[x(0), x(1), . . . , x(L−1)], the AACF of the sequence may be defined as:

$${C}_{x} ( k ) = {\sum }_{n = 0}^{L - 1 - k} x ( n ) x ( n + k ) , 0 \leq k \leq L - 1$$

y represents a displacement, and represents the zero displacement when k is equal to 0. The AACF of the sequence y (represented as C_{y}(k)) is similar to the AACF of the sequence x. For details, refer to the descriptions of Cₓ(k). Details are not described herein again.

For example, for sequences x=[1, 1, 1, −1] and y=[1, 1, −1, 1], the AACF of the sequence x is Cₓ=[4, 1, 0, −1], k=0, . . . , 3, and the AACF of the sequence y is C_{y}=[4, −1, 0, 1], k=0, . . . , 3. As Cₓ+C_{y}=[8, 0, 0, 0], the sequences x and y are one GCP.

### (6) Ambiguity Function

The ambiguity function may be for measuring impact of a Doppler shift and a transmission delay on a sent signal. The Doppler shift is caused by movement of a target object, and may be approximately equivalent to continuous phase rotation on a continuous-time signal sent by a sending end.

In a scenario in which multiple sequences may need to be sent, a sending end may sequentially generate, based on the multiple sequences, a continuous-time signal that is to carry the multiple sequences, and send the signal. The continuous-time signal received by a receiving end may be affected by a Doppler frequency domain. Therefore, the receiving end may measure, by using an ambiguity function, impact of the Doppler shift on the sent signal (or the multiple sent sequences).

Sending multiple sequences may cause an ambiguity function of the multiple sequences to generate a low ambiguity zone. The low ambiguity zone of the ambiguity function may be determined based on a threshold. In the low ambiguity zone of the ambiguity function, values of the ambiguity function are all less than or equal to the threshold. In other words, the low ambiguity zone of the ambiguity function is a zone in which a value of the ambiguity function is less than or equal to a specific threshold.

The low ambiguity zone enables a receiver to detect a location and/or a velocity of the target object more accurately. In addition, in the low ambiguity zone, multiple target objects may be more accurately distinguished, and locations and/or velocities of the target objects are separately detected. Generally, a larger range of the low ambiguity zone indicates that a larger velocity range can be detected and more target objects can be distinguished in a specific velocity range.

### (7) Time Unit

In embodiments of this disclosure, the time unit may be a consecutive period of time or a segment of consecutive time domain resources. A time domain signal may be converted into a frequency domain signal through a Fourier transform, in other words, a time domain signal sent on a segment of time domain resources may be converted into a frequency domain signal. Therefore, this may also mean: A segment of consecutive time domain resources corresponds to a segment of frequency domain resources. Further, the time domain resources and the frequency domain resources corresponding to the time domain resources may be collectively referred to as time-frequency resources.

In sensing and radar systems, in addition to a location of a moving target (which may be understood as a receiving apparatus or a sensing target), a velocity (or Doppler) of the moving target also may need to be measured. In one approach, a sending apparatus sends multiple sequences (sequence train) and receives signals reflected by a moving target, and the sending apparatus performs detection based on the received signals. The sending apparatus may calculate an ambiguity function of the received signal, and detect a location and a velocity of the target from the ambiguity function. A desirable ambiguity function is obtained by designing the multiple sent sequences. The ambiguity function may be a two-dimensional delay-Doppler ambiguity function. Sending multiple sequences may cause the ambiguity function to generate a low ambiguity zone in which values of the ambiguity function are very low, or in other words, sidelobe leakage is very low. Therefore, the sending apparatus can detect the location and the velocity of the moving target more accurately based on the signals reflected by the moving target.

In some scenarios, when multiple moving targets may need to be detected at the same time, if the multiple detected moving targets are all located within a low ambiguity zone, the multiple moving targets can also be identified, and a location and a velocity are detected for each moving target. However, detecting multiple moving targets at the same time may cause mutual interference, resulting in inaccurate detection of each moving target.

In view of this, this disclosure provides a sequence sending method. When multiple moving targets may need to be detected at the same time, mutual interference between the multiple moving targets can be avoided, improving detection accuracy of each moving target.

The method provided in embodiments of this disclosure may be applied to various communication systems. The communication system may be a global system for mobile communications (GSM), a 3rd Generation Partnership Project (3GPP) communication system, for example, a 4th generation (4G) or 5th generation (5G) mobile communication system, or a 6th generation (6G) mobile communication system that evolves from 5G, a vehicle-to-everything (V2X) system, a device-to-device (D2D) communication system, a machine-to-machine (M2M) communication system, an internet of things (IoT), a narrowband internet of things (NB-IoT), another next-generation communication system, an integrated sensing and communication system, a satellite communication system, an enhanced data rate for GSM evolution (EDGE) system, a wideband code-division multiple access (WCDMA) system, a code-division multiple access 2000 (CDMA2000) system, a time division-synchronous code division multiple access (TD-SCDMA) system, a Long-Term Evolution (LTE) system, and three major application scenarios of a next-generation 5G mobile communication system: eMBB, ultra-reliable and low latency communications (URLLC), and eMTC. The communication system may alternatively be a non-3GPP communication system, for example, a wireless local area network (WLAN) system such as a Wi-Fi system. This is not limited.

The technical solutions in embodiments of this disclosure may be applied to various communication scenarios, for example, a sensing scenario.

The foregoing communication systems and communication scenarios to which this disclosure is applicable are merely examples for description, communication systems and communication scenarios to which this disclosure is applicable are not limited thereto, and the foregoing descriptions do not constitute any limitation on the solutions of this disclosure.

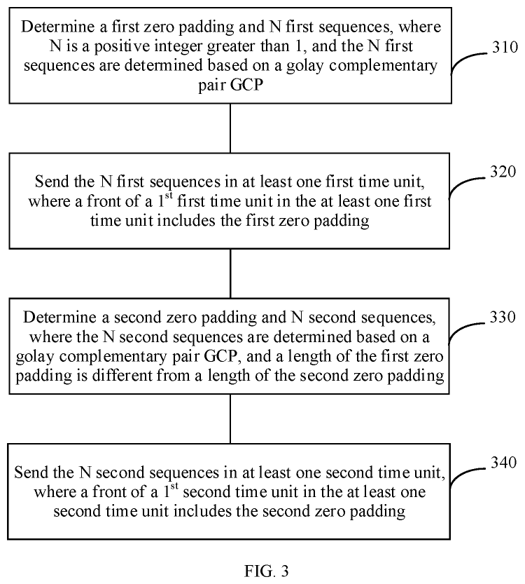

FIG. 2 is a diagram of a structure of a communication system according to an embodiment of this disclosure. The communication system includes at least one terminal device and at least one network device. For ease of description, an example in which two terminal devices and one network device are included is used for description in FIG. 2.

The terminal device in embodiments of this disclosure may be a user-side device, for example, a terminal or a chip that may be used in the terminal, configured to implement a wireless communication function. The terminal may be user equipment (UE), an access terminal, a terminal unit, a terminal station, a mobile station, a remote station, a remote terminal, a mobile device, a wireless communication device, a terminal agent, a terminal apparatus, or the like in a 5G network or a public land mobile network (PLMN) that evolves from 5G. The access terminal may be a cellular phone, a cordless phone, a Session Initiation Protocol (SIP) phone, a wireless local loop (WLL) station, a personal digital assistant (PDA), a handheld device having a wireless communication function, a compute device or another processing device connected to a wireless modem, a vehicle-mounted device, an uncrewed aerial vehicle, a robot, a smart point of sale (POS) machine, customer-premises equipment (CPE) or a wearable device, a virtual reality (VR) terminal device, an augmented reality (AR) terminal device, a wireless terminal in industrial control, a wireless terminal in self-driving, a wireless terminal in telemedicine (remote medical), a wireless terminal in smart grid, a wireless terminal in transportation safety, a wireless terminal in smart city, a wireless terminal in smart home, or the like. Alternatively, the terminal may be a terminal having a communication function in the IoT, for example, a terminal in V2X (for example, an Internet of Vehicles device), a terminal in D2D communication, or a terminal in M2M communication. The terminal may be mobile or stationary.

The network device in embodiments of this disclosure is a device that connects the terminal device to a wireless network. The network device may be referred to as a node in a radio access network (RAN), or may be referred to as a radio access network node (or device). A communication system may include multiple network devices, and the network devices may be nodes of a same type or nodes of different types.

In some possible scenarios, the network device may include an evolved NodeB (eNB) in an LTE system or an LTE Advanced (LTE-A) system, for example, a macro-eNB, and a micro-eNB in a heterogeneous network scenario. Alternatively, the network device may include a next generation NodeB (gNB) in a new radio (NR) system. Alternatively, the network device may include a transmission reception point (TRP), a home NodeB (HNB), a baseband unit (BBU), a baseband unit pool (BBU pool), a Wi-Fi access point (AP), or the like. Alternatively, the network device may include a base station in a non-terrestrial network (NTN), to be specific, may be deployed on a flying platform or a satellite. In the NTN, the network device may serve as a layer 1 (L1) relay, may serve as a base station, or may serve as an integrated access and backhaul (IAB) node. Alternatively, the network device may be a device that is in an IoT and that implements functions of a base station, for example, a device that is in uncrewed aerial vehicle communication, V2X, D2D, or M2M and that implements the functions of the base station.

In addition, the network device may alternatively be a device that communicates with a terminal device in a 6G system, for example, a gNB in the 6G system.

In some possible scenarios, the network device may alternatively be a module or unit that can implement some functions of a base station. For example, the network device may be a central unit (CU), a distributed unit (DU), a CU-control plane (CP), a CU-user plane (UP), or a radio unit (RU). The CU and the DU may be separately arranged, or may be included in a same network element, for example, a baseband unit (BBU). The RU may be included in a radio frequency device or a radio frequency unit, for example, included in a remote radio unit (RRU), an active antenna unit (AAU), or a remote radio head (RRH).

In different systems, the CU (or the CU-CP and the CU-UP), the DU, or the RU may also have different names, but a person skilled in the art may understand meanings thereof. For example, the network device may be a network device in an open radio access network (ORAN) system or a module of the network device. In the ORAN system, the CU may also be referred to as an open (O)-CU, the DU may also be referred to as an O-DU, the CU-CP may also be referred to as an O-CU-CP, the CU-UP may also be referred to as an O-CU-UP, and the RU may also be referred to as an O-RU. Any one of the CU (or the CU-CP or the CU-UP), the DU, and the RU in this disclosure may be implemented by using a software module, a hardware module, or a combination of the software module and the hardware module.

For example, in the CU-DU architecture and the ORAN architecture, the network device may be divided into modules. The method provided in this disclosure may be performed by a same module, or may be performed by different modules. This is not specifically limited in this disclosure.

Optionally, the CU and the DU may be obtained through division based on protocol layers of a wireless network. For example, functions of a Packet Data Convergence Protocol (PDCP) layer and protocol layers (for example, a radio resource control (RRC) layer and a Service Data Adaptation Protocol (SDAP) layer) above the PDCP layer are set on the CU, and functions of a protocol layer (for example, a radio link control (RLC) layer, a media access control (MAC) layer, or a physical layer (PHY)) below the PDCP layer are set on the DU. For another example, functions of a protocol layer above the PDCP layer are set on the CU, and functions of the PDCP layer and a protocol layer below the PDCP layer are set on the DU. This is not limited.

The division into processing functions of the CU and the DU based on protocol layers is merely an example, and may be division in another manner. For example, the CU or the DU may have functions of more protocol layers through division. For another example, the CU or the DU may have some processing functions of protocol layers through division. For example, part of functions of the RLC layer and a function of a protocol layer above the RLC layer are set on the CU, and remaining functions of the RLC layer and a function of a protocol layer below the RLC layer are set on the DU. For another example, division into functions of the CU or the DU may alternatively be performed based on service types or other system requirements. For example, division may be performed based on latencies. Functions whose processing time may need to meet a latency requirement are set on the DU, and functions whose processing time does not need to meet the latency requirement are set on the CU.

Optionally, the base station in embodiments of this disclosure may include various forms of base stations, for example, a macro base station, a micro base station (also referred to as a small cell), a relay station, an access point, a home NodeB, a TRP, a transmission point (TP), and a mobile switching center. This is not specifically limited in embodiments of this disclosure.

It should be noted that the communication system described in embodiments of this disclosure is intended to describe the technical solutions in embodiments of this disclosure more clearly, but constitutes no limitation on the technical solutions provided in embodiments of this disclosure. A person of ordinary skill in the art may learn that the technical solutions provided in embodiments of this disclosure are also applicable to a similar technical problem as a network architecture evolves and a new service scenario emerges.

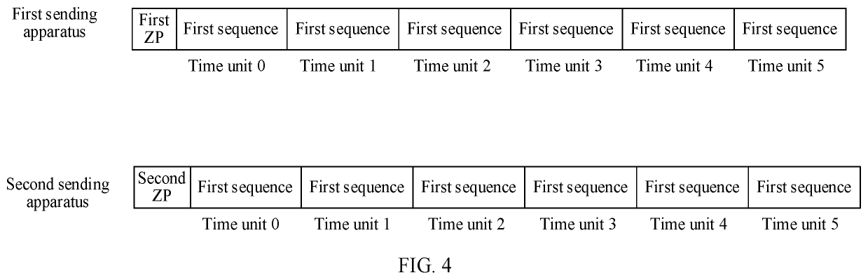

With reference to FIG. 3, the following describes in detail the method provided in embodiments of this disclosure. It may be understood that, in embodiments of this disclosure, these steps or operations are merely examples. In embodiments of this disclosure, other operations or variations of various operations may be further performed. In addition, the steps may be performed in a sequence different from that presented in embodiments of this disclosure, and not all the operations in embodiments of this disclosure may be necessarily performed.

FIG. 3 is a block diagram of a sequence sending method according to this disclosure. As shown in FIG. 3, the method may include steps 310 to 340. The following describes steps 310 to 340 in detail.

Step 310: Determine a first zero padding and N first sequences, where N is a positive integer greater than 1, and the N first sequences are determined based on a GCP.

For example, step 310 may be performed by a first communication apparatus. The first communication apparatus may be the terminal device in FIG. 2, or may be the network device in FIG. 2. This is not specifically limited in this embodiment of this disclosure.

The first zero padding (ZP) is to pad a digit 0 before the N first sequences, or to send no signal in a length of the first zero padding before the N first sequences. The zero padding may also be referred to as a gap.

In this embodiment of this disclosure, the N first sequences are determined based on a GCP. Specifically, each of the N first sequences may be a sequence in the GCP, or may be generated based on a sequence in the GCP. This is not specifically limited in this embodiment of this disclosure.

Optionally, a GCP sequence corresponding to the N first sequences may be determined based on an extension sequence. The extension sequence includes N elements, and the N elements are in one-to-one correspondence with the N first sequences. Specifically, a sequence that is of the GCP and that corresponds to an n^{th} first sequence of the N first sequences is determined based on an n^{th} element in the extension sequence, and the n^{th} first sequence is generated based on the sequence that is of the GCP and that corresponds to the n^{th} first sequence.

In an example, each of the N first sequences is a sequence x or a sequence y in the GCP. In some possible implementations, whether a first sequence is the sequence x or the sequence y may be determined in the following two manners.

### Manner 1: Perform Determining Based on a Prouhet-Thue-Morse (PTM) Sequence:

The PTM sequence is a binary sequence, to be specific, a value of each element in the PTM sequence is 1 or −1, or is 0 or 1.

When the N first sequences to be sent are determined based on the PTM sequence, the PTM sequence is the extension sequence corresponding to the N first sequences. The N elements of the PTM sequence are in one-to-one correspondence with the N first sequences. The quantity N of sequences is a power of 2, that is N=2^{M}, where M is a positive integer.

For example, the following may be defined: A value of an element in the PTM sequence being 1 corresponds to a first sequence being the sequence x in the GCP; and correspondingly, a value of an element in the PTM sequence being −1 corresponds to a first sequence being the sequence y in the GCP. Alternatively, the following may be defined: A value of an element in the PTM sequence being 0 corresponds to a first sequence being the sequence x in the GCP; and correspondingly, a value of an element in the PTM sequence being 1 corresponds to a first sequence being the sequence y in the GCP.

For example, a PTM sequence with M=4 and N=16 is [1, −1, −1, 1, −1, 1, 1, −1, −1, 1, 1, −1, 1, −1, −1, 1] or [0, 1, 1, 0, 1, 0, 0, 1, 1, 0, 0, 1, 0, 1, 1, 0]. In this case, 16 first sequences correspondingly sent should be [x, y, y, x, y, x, x, y, y, x, x, y, x, y, y, x].

It should be noted that, in embodiments of this disclosure, unless otherwise specified, x represents the sequence x in the GCP, and y represents the sequence y in the GCP. Unified descriptions are provided herein, and details are not described in the following embodiment again.

### Manner 2: Perform Determining Through GCP Repetition:

In this manner, the sequence x and the sequence y in the GCP may be repeated to obtain the N first sequences. For example, when N=16, 16 corresponding first sequences may be [x, y, x, y, x, y, x, y, x, y, x, y, x, y, x, y]. When N=15, 15 corresponding first sequences may be [x, y, x, y, x, y, x, y, x, y, x, y, x, y, x].

In analogy with the manner 1, an extension sequence may also be defined in the manner 2. An element in the extension sequence being 1 (or 0) corresponds to a first sequence being the sequence x in the GCP, and an element in the extension sequence being −1 (or 1) corresponds to a first sequence being the sequence y in the GCP

For example, when N=16, a corresponding extension sequence may be [1, −1, 1, −1, 1, −1, 1, −1, 1, −1, 1, −1, 1, −1, 1, −1] or [0, 1, 0, 1, 0, 1, 0, 1, 0, 1, 0, 1, 0, 1, 0, 1]. When N=15, a corresponding extension sequence may be [1, −1, 1, −1, 1, −1, 1, −1, 1, −1, 1, −1, 1, −1, 1] or [0, 1, 0, 1, 0, 1, 0, 1, 0, 1, 0, 1, 0, 1, 0].

Alternatively, whether a first sequence is the sequence x or the sequence y may be determined in another manner (for example, a value of another extension sequence). This is not specifically limited in this embodiment of this disclosure.

Step 320: Send the N first sequences in at least one first time unit, where a front of a 1st first time unit in the at least one first time unit includes the first zero padding.

For example, step 320 may be performed by the first communication apparatus.

In this embodiment of this disclosure, the first communication apparatus may sequentially send the N first sequences to a receiving device in the at least one first time unit, where the front of the 1^{st} first time unit in the at least one first time unit includes the first ZP. In other words, the first ZP is sent before a 1^{st} first sequence of the N first sequences.

Optionally, the first communication apparatus may sequentially send the N first sequences to the receiving device in the at least one first time unit.

Optionally, because a signal (that is, a value of an element) in the first zero padding is 0, it may be understood that the first communication apparatus does not send the first zero padding.

For example, in one first time unit, one of the N first sequences may be sent, or multiple first sequences of the N first sequences may be sent. This is not specifically limited in this embodiment of this disclosure.

Optionally, after the first communication apparatus sends the N first sequences to the receiving device, the first ZP and the N first sequences are reflected by the receiving apparatus and received by the first communication apparatus. In other words, the first communication apparatus further receives the N first sequences reflected by the receiving apparatus, and the first communication apparatus senses a location and/or a moving velocity of the receiving apparatus based on the received N first sequences. Specifically, the first communication apparatus may perform aperiodic correlation calculation on the N sent first sequences and the N received first sequences reflected by the receiving apparatus, calculate an ambiguity function, and detect the location and the velocity of the receiving apparatus from the ambiguity function.

Step 330: Determine a second zero padding and N second sequences, where the N second sequences are determined based on a GCP, and a length of the first zero padding is different from a length of the second zero padding.

For example, step 330 may be performed by a second communication apparatus. The second communication apparatus may be the terminal device in FIG. 2, or may be the network device in FIG. 2. This is not specifically limited in this embodiment of this disclosure. In a possible implementation, the first communication apparatus is the terminal device in FIG. 2, and the second communication apparatus is also the terminal device in FIG. 2. In another possible implementation, the first communication apparatus is the network device in FIG. 2, and the second communication apparatus is also the network device in FIG. 2. For example, the first communication apparatus and the second communication apparatus may be a same network device, or may be different network devices. This is not limited in this embodiment of this disclosure. If the first communication apparatus and the second communication apparatus are a same network device, the first communication apparatus and the second communication apparatus may be different ports on the same network device.

The second ZP is to pad a digit 0 before the N second sequences. A length of digits 0 padded before the N second sequences is different from a length of digits 0 padded before the N first sequences, that is, the length of the second ZP is different from the length of the first ZP.

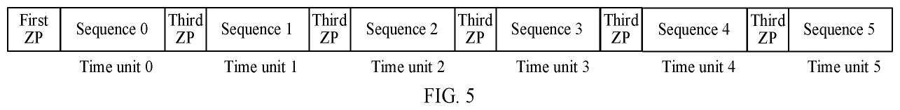

For example, as shown in FIG. 4, an example of six time units is used, and the time units are sequentially numbered as a time unit 0 to a time unit 5 (or numbered as a 0^{th} time unit to a 5^{th} time unit). The six time units in FIG. 4 are sequentially and consecutively arranged in time and do not overlap each other. (a) in FIG. 4 includes a first ZP padded before six first sequences, and (b) in FIG. 4 includes a second ZP padded before six second sequences. A length of the first ZP is different from a length of the second ZP.

It should be noted that the first sequence may be directly sent in the time unit, or data obtained through processing the first sequence may be sent. For example, the first sequence is processed to obtain a time domain signal, and the time domain signal is finally sent in the time unit.

In this embodiment of this disclosure, each second sequence included in the N second sequences is determined based on a GCP. Specifically, each of the N second sequences is a sequence in the GCP, or is generated based on a sequence in the GCP. This is not specifically limited in this embodiment of this disclosure. For a specific manner of generating each of the N second sequences, refer to the manner of generating each of the N first sequences. Details are not described herein again.

Step 340: Send the N second sequences in at least one second time unit, where a front of a 1^{st} second time unit in the at least one second time unit includes the second zero padding.

For example, step 340 may be performed by the second communication apparatus.

In this embodiment of this disclosure, the second communication apparatus may sequentially send the N second sequences to a receiving device in the at least one second time unit, where the front the 1^{st} first time unit in the at least one first time unit includes the second ZP. In other words, the second ZP is sent before a 1^{st} second sequence of the N second sequences.

For example, in one second time unit, one of the N second sequences may be sent, or multiple second sequences of the N second sequences may be sent. This is not specifically limited in this embodiment of this disclosure.

In this embodiment of this disclosure, the time unit may be represented by a symbol, and one time unit may include at least one symbol. The symbol may be a single-carrier symbol, a single-carrier quadrature amplitude modulation (SC-QAM) symbol, or an SC-FDMA symbol.

It should be understood that a length of the first time unit is the same as a length of the second time unit. In addition, the first time unit and the second time unit may also be represented in a same manner. For example, a type of a symbol representing the first time unit is the same as a type of a symbol representing the second time unit.

In the foregoing technical solution, two sequences of a GCP have a property of ideal aperiodic correlation. When a target is sensed by using multiple sequences generated based on the GCP sequence, for example, by calculating an ambiguity function, a length of a zero padding (that is, the length of the first ZP) at a front of the sequences is related to a peak position of the target determined in the ambiguity function. When multiple sequences are sent by using different zero padding lengths, a same detection target has different peak positions in the ambiguity function, and maintenance of the property of ideal aperiodic correlation can still be assumed in a low-velocity regime. Therefore, values of multiple possible zero padding lengths are designed, so that multiple targets can be detected, peak positions corresponding to the multiple detected targets are more easily distinguished, and interference between the multiple detected targets is mitigated.

Optionally, in some embodiments, an end of each of the at least one first time unit includes a third zero padding, and the third zero padding is used to separate the at least one first time unit.

Optionally, in some embodiments, if the at least one first time unit is consecutive, an end of a last first time unit in the at least one first time unit includes a fourth zero padding, and a length of the fourth zero padding is related to the length of the first zero padding.

In the foregoing technical solution, when the N first sequences are sent in multiple consecutive first time units and the N second sequences are sent in multiple consecutive second time units, because the length of the first zero padding is different from the length of the second zero padding, duration of sending the N first sequences is different from duration of sending the N second sequences. In this case, the fourth ZP is introduced, and the length of the fourth ZP is related to the length of the first ZP, so that for different lengths of the first ZP, adjustment may be made to cause the duration of sending the N first sequences to equal the duration of sending the N second sequences, and the N first sequences and the N second sequences may be sent in same duration, simplifying a time domain structure of a sent sequence and avoiding interference with a signal of another type.

It should be noted that a sequence of performing the steps in FIG. 3 is not specifically limited in this embodiment of this disclosure. For example, step 310 to step 320 may be performed before step 330 to step 340; or step 330 to step 340 may be performed before step 310 to step 320. For another example, step 310 and step 320 may be performed separately, or may be performed in parallel. Similarly, step 330 and step 340 may be performed separately, or may be performed in parallel.

Optionally, in some embodiments, if the at least one first time unit is inconsecutive, the front of each of the at least one first time unit includes the first ZP.

Optionally, in some embodiments, if the at least one first time unit is inconsecutive, the front of each first time unit of the at least one first time unit includes the first ZP, and the end of each of the at least one first time unit includes the fourth ZP. In this way, when the first communication apparatus sends the N first sequences in multiple inconsecutive first time units, for different lengths of the first ZP, duration of the first ZP plus each first time unit varies. In this case, the fourth ZP located at the end of each first time unit is introduced, and the length of the fourth ZP is related to the length of the first ZP. Therefore, for different lengths of the first ZP, adjustment may be made to cause same duration of each first time unit plus the first ZP plus the fourth ZP. Therefore, sequences can be sent in same duration, simplifying a time domain structure of a sent sequence and avoiding interference with a signal of another type.

Optionally, in some embodiments, an end of each of the at least one second time unit includes a fifth ZP, and the fifth ZP is used to separate the at least one second time unit.

Optionally, in some embodiments, if the at least one second time unit is consecutive, an end of a last second time unit in the at least one second time unit includes a sixth ZP, and a length of the sixth ZP is related to the length of the second ZP. A sum of the length of the first zero padding and the length of the fourth zero padding is the same as a sum of the length of the second zero padding and the length of the sixth zero padding.

In the foregoing technical solution, when the N first sequences are sent in multiple consecutive second time units and the N second sequences are sent in multiple consecutive second time units, because the length of the first zero padding is different from the length of the second zero padding, duration of sending the N first sequences is different from duration of sending the N second sequences. In this case, the sixth ZP is introduced, and the length of the sixth ZP is related to the length of the second ZP, so that for different lengths of the first ZP, adjustment may be made to cause the duration of sending the N first sequences to equal the duration of sending the N second sequences, and the N first sequences and the N second sequences may be sent in same duration, simplifying a time domain structure of a sent sequence and avoiding interference with a signal of another type.

Optionally, in some embodiments, if the at least one second time unit is inconsecutive, the front of each of the at least one second time unit includes the second ZP.

Optionally, in some embodiments, if the at least one second time unit is inconsecutive, the front of each of the at least one second time unit includes the second ZP, and the end of each of the at least one second time unit includes the sixth ZP. In this way, when the second communication apparatus sends sequences in multiple inconsecutive second time units, for different lengths of the second ZP, duration of the second ZP plus each second time unit varies. In this case, the sixth ZP located at the end of each second time unit is introduced, and the length of the sixth ZP is related to the length of the second ZP. Therefore, for different lengths of the second ZP, adjustment may be made to cause same duration of each second time unit plus the second ZP plus the sixth ZP. Therefore, sequences can be sent in same duration, simplifying a time domain structure of a sent sequence and avoiding interference with a signal of another type.

The following uses an example in which the first communication apparatus sequentially sends N sequences in Nᵤ time units to describe in detail a process in which the first communication apparatus sends multiple sequences.

Implementation 1: The Nᵤ time units are consecutive and do not overlap each other, where Nᵤ is a positive integer, and N is a positive integer greater than 1.

Duration (or referred to as a time length) of one time unit may be represented as Lᵤ×Tₛ. Tₛ represents a unit of time (or referred to as a sampling interval). Tₛ may be determined based on a subcarrier spacing. For example, when the subcarrier spacing is 15 kilohertz (kHz), Tₛ may be 1/(2048×15000) second (s).

Lᵤ may be understood as a quantity of discrete points (or referred to as sampling points) in a time unit, and a time interval between any two adjacent discrete points is Tₛ. In other words, Lᵤ discrete points (or discrete time domain positions) may be obtained by dividing (or sampling) the time unit at an interval of T.

Optionally, a value of Lᵤ may be greater than or equal to a length of a sequence sent in the time unit.

In addition, Lᵤ may also be referred to as a length of a time unit. In other words, in embodiments of this disclosure, the duration of the time unit may be a continuous time length, and the length of the time unit may be the quantity of discrete points. The length of the time unit being Lᵤ may also be understood as that Lᵤ discrete values may be sent in the time unit.

Optionally, one time unit may be one SC-FDMA symbol or one OFDM symbol. For example, duration of one SC-FDMA symbol or one OFDM symbol is Lᵤ×Tₛ.

Optionally, one time unit may include at least one single-carrier symbol or SC-QAM symbol. For example, when the length of one time unit is Lᵤ, the time unit may include Lᵤ single-carrier symbols or include Lᵤ SC-QAM symbols. One value (for example, one complex value) may be sent on each single-carrier symbol or each SC-QAM symbol. Duration of each single-carrier symbol or each SC-QAM symbol is Tₛ.

Optionally, when a length of one time unit is Lᵤ, the time unit may include at least one SC-FDMA symbol.

In the implementation 1, the Nᵤ time units are consecutive and do not overlap each other, a 1^{st} time unit in the Nᵤ time units includes a first ZP, an end of each time unit includes a third ZP, and a length of the third ZP is greater than 0. In other words, the third ZP separates different time units.

Duration of one third ZP may be represented as L_{3,zero}Tₛ. One third ZP is sampled at a time interval (or referred to as a sampling interval) of Tₛ, to obtain L_{3,zero} discrete sampling points. Values of the L_{3,zero} discrete sampling points are 0 or approximately 0. L_{3,zero} may be referred to as the length of the third ZP.

Optionally, the third ZP corresponding to the time unit may also be included in the time unit, that is, the duration of the time unit is (Lᵤ+L_{3,zero})Tₛ, and a signal whose duration is L_{3,zero} Tₛ at the end is the third ZP.

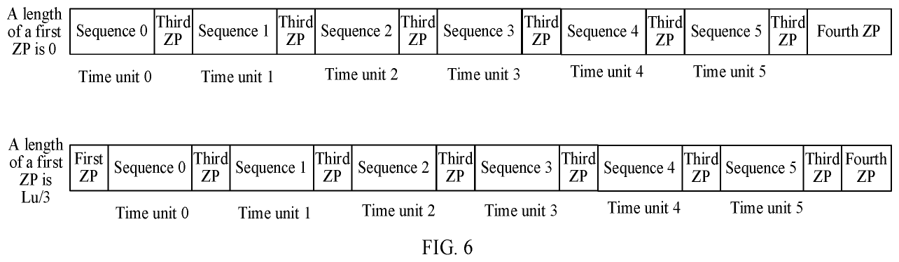

For example, as shown in FIG. 5, there are Nᵤ=6 time units in FIG. 5, which are sequentially numbered from a time unit 0 to a time unit 5 (or numbered from a 0^{th} time unit to a 5^{th} time unit). The six time units in FIG. 5 are sequentially and consecutively arranged in time, a 1^{st} time unit in the six time units includes a first ZP, and an end of each time unit includes a third ZP.

Optionally, a length of the third ZP is the same across time units, or a length of the third ZP may vary between time units. This is not limited in this disclosure.

In this embodiment of this disclosure, because GCP sequences have a property of ideal aperiodic correlation, adding a third ZP to the end of each time unit can support aperiodic correlation of a sequence sent in the time unit.

One or more sequences may be sent in each time unit and each sequence is the sequence x or the sequence y of the GCP. For example,

$${N}_{1 unit}^{seq}$$

sequences are sent in each time unit, where

$${N}_{1 unit}^{seq}$$

is a positive integer. Because the N sequences are sequentially sent in the Nᵤ time units,

$$N = {N}_{1 unit}^{seq} \times {N}_{u} .$$

Sequences sent in the Nᵤ time units are in one-to-one correspondence with the N sequences. Specifically, a 0^{th} sequence to an

$${( {N}_{1 unit}^{seq} - 1 )}^{th}$$

sequence of the N sequences are in one-to-one correspondence with

$${N}_{1 unit}^{seq}$$

sequences in a 0^{th} time unit in the Nᵤ time units (that is, a 0^{th} sequence to an

$${( {N}_{1 unit}^{seq} - 1 )}^{th}$$

sequence in the 0^{th} time unit), and an

$${( {N}_{1 unit}^{seq} )}^{th}$$

sequence to a

$${( 2 {N}_{1 unit}^{seq} - 1 )}^{th}$$

sequence of the N sequences are in one-to-one correspondence with

$${N}_{1 unit}^{seq}$$

sequences in a 1^{st} time unit in the Nᵤ time units (that is, a 0^{th} sequence to an

$${( {N}_{1 unit}^{seq} - 1 )}^{th}$$

sequence in the 1^{st} time unit), and so on.

Therefore, if the N sequences are determined, a sequence sent in each time unit is determined.

A sequence sent in each time unit may be generated based on an extension sequence. A possible value of the extension sequence may be a value A and a value B. Let the sequence x correspond to the value A, and let the sequence y correspond to the value B. Because each first sequence corresponds to the sequence x or the sequence y, it may be learned that the N first sequences are in one-to-one correspondence with N values, and each of the N values is A or B. A sequence including the N values is the extension sequence. Therefore, after the extension sequence is determined, the N first sequences may be determined.

For example, N=18, and the extension sequence may be represented as sₑₓₜ=[A, B, B, A, A, B, A, B, B, A, A, B, A, B, B, A, A, B]. When the values of A and B are 1 and −1 respectively, sₑₓₜ=[1, −1, −1, 1, 1, −1, 1, −1, −1, 1, 1, −1, 1, −1, −1, 1, 1, −1], and correspondingly, N=18 sequences are x, y, y, x, x, y, x, y, y, x, x, y, x, y, y, x, x, y.

Lengths of the N sequences may be the same, and are represented as L_{seq}. Optionally, L_{seq}=Lᵤ.

Optionally, a quantity of elements in the extension sequence is represented as Nₑₓₜ, and the quantity Nₑₓₜ of elements in the extension sequence may be greater than N. N elements in the extension sequence are in one-to-one correspondence with the N sequences (the N first sequences or the N second sequences).

For example, a possible value of the extension sequence may be a value A, a value B, or a value C. Let the sequence x correspond to the value A, let the sequence y correspond to the value B, and let the value C to indicate that no sequence is sent. It is assumed that the first sequence is the sequence x or the sequence y. In this case, values of Nₑₓₜ elements in the extension sequence are determined, the N first sequences are determined.

For example, the value A=1, the value B=−1, the value C=0, and the extension sequence is sₑₓₜ=[1, −1, −1, 0, 1, 1, −1].

In some embodiments, when the Nᵤ time units are consecutive time units, the front of the Nᵤ time units includes the first ZP, and the length of the first ZP has at least two different values.

The length of the first ZP is represented as L_{1,zero}, and L_{1,zero} may have N_{1,zero} values, where N_{1,zero} is a positive integer greater than 1, and any two of the N_{1,zero} values are different. For example, N_{1,zero}=3, and possible values of L_{1,zero} are 0, Lᵤ/3, and 2Lᵤ/3.

It should be understood that, if Lᵤ cannot be exactly divided by 3, generally, rounding down may be performed.

The N_{1,zero} values of the length of the first ZP may be predefined, or may be indicated based on signaling.

The N_{1,zero} values of the length of the first ZP may be related to the length of the second ZP. For example, N_{1,zero}=└Lᵤ/L_{2,zero}┘, and the N_{1,zero} values are 0, L_{2,zero}, . . . , and (N_{1,zero}−1)L_{2,zero}, where └ ┘ indicates rounding down.

Optionally, the length of the first ZP corresponds to the extension sequence. Different extension sequences may correspond to different lengths of the first ZP.

Optionally, an end of the Nᵤ time units further includes the fourth ZP, and the length of the fourth ZP is related to the length of the first ZP. For example, the sum of the length of the fourth ZP and the length of the first ZP is a constant. That is, for different lengths of the first ZP, the sum of the length of the fourth ZP and the length of the first ZP remains the same. For example, the length of the fourth ZP is represented as L_{4,zero}, and the sum of the length of the fourth ZP and the length of the first ZP is L_{4,zero}+L_{1,zero}=Lᵤ, or L_{4,zero}+L_{1,zero}=Lᵤ+L_{3,zero}.

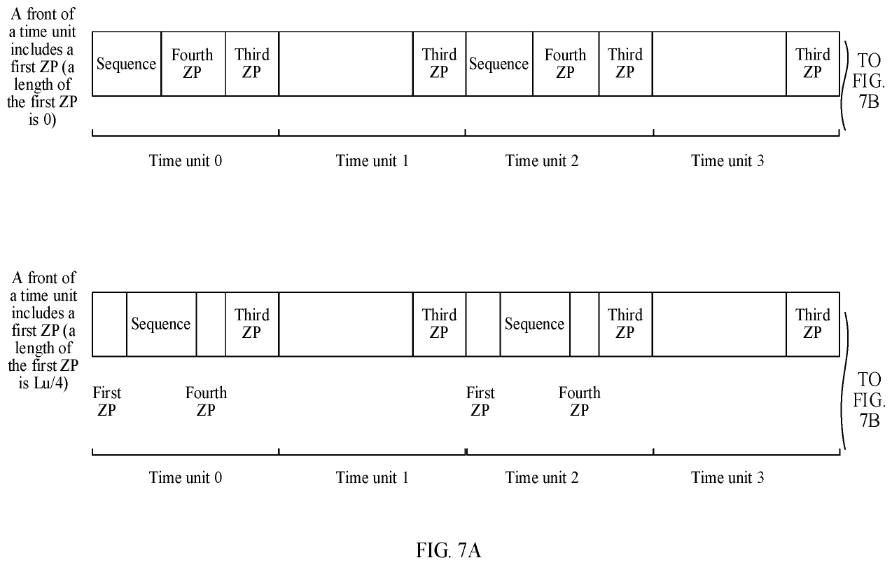

An example in which one time unit includes Lᵤ single-carrier symbols is used. As shown in FIG. 6, the quantity of time units is Nᵤ=6, one sequence is sent in each time unit, and a total of N=6 sequences are sent. The extension sequence is sₑₓₜ=[A, B, A, B, A, B], and six sequences correspondingly sent are x, y, x, y, x, and y. The length of the first ZP includes two values: 0 and Lᵤ/3, and the sum of the length of the first ZP and the length of the fourth ZP is Lᵤ+L_{3,zero}. The sum of the length of the first ZP and the length of the fourth ZP is the sum of the length of one time unit and the length of the third ZP. Therefore, for different lengths of the first ZP, total duration of sending sequences is a sum of duration of seven time units and duration of seven third ZPs. In other words, total duration of sending sequences remains the same.

It should be noted that the length of the first ZP being 0 in FIG. 6 may be understood as that a quantity of elements (that is, a quantity of digits 0) in the first ZP is 0, and the length of the first ZP being Lᵤ/3 may be understood as that a quantity of elements (that is, a quantity of digits 0) in the first ZP is Lᵤ/3.

It should be understood that, values of the two different lengths of the first ZP may respectively correspond to the first ZP sent by the first communication apparatus and the second ZP sent by the second communication apparatus, and the length of the second ZP is different from the length of the first ZP.

When the length L_{seq} of the sequence is the same as the length Lᵤ of the time unit, the sequence may be directly sent in the time unit in the foregoing figure. For example, one time unit includes Lᵤ single-carrier symbols, and one value (for example, one complex value) is sent on each single-carrier symbol. One single-carrier symbol in one time unit corresponds to one value of a sent sequence in the time unit.

When the length of the sequence is less than the length of the time unit, operations such as upsampling and filtering may be performed on the sequence, and then the sequence is sent in the time unit corresponding to the sequence, or an OFDM symbol or an SC-FDMA symbol is generated based on the sequence, and then the OFDM symbol or the SC-FDMA symbol is sent in the time unit corresponding to the sequence.

Implementation 2: The Nᵤ time units are arranged inconsecutively.

When the Nᵤ time units are inconsecutive time units, the front of each of the Nᵤ time units includes the first ZP, and the length of the first ZP has at least two different values; and the end of each of the Nᵤ time units includes the fourth ZP, and the length of the fourth ZP is related to the length of the first ZP.

For example, the sum of the length of the fourth ZP and the length of the first ZP is a constant. That is, for different lengths of the first ZP, the sum of the length of the fourth ZP and the length of the first ZP remains the same. For example, the length of the fourth ZP is represented as L_{4,zero}, and the sum of the length of the fourth ZP and the length of the first ZP is L_{4,zero}+L_{1,zero}=Lᵤ/2.

Optionally, the sum of the length of the fourth ZP, the length of the first ZP, and the length of the sequence is a constant, for example, L_{4,zero}+L_{1,zero}+L_{seq}=Lᵤ.

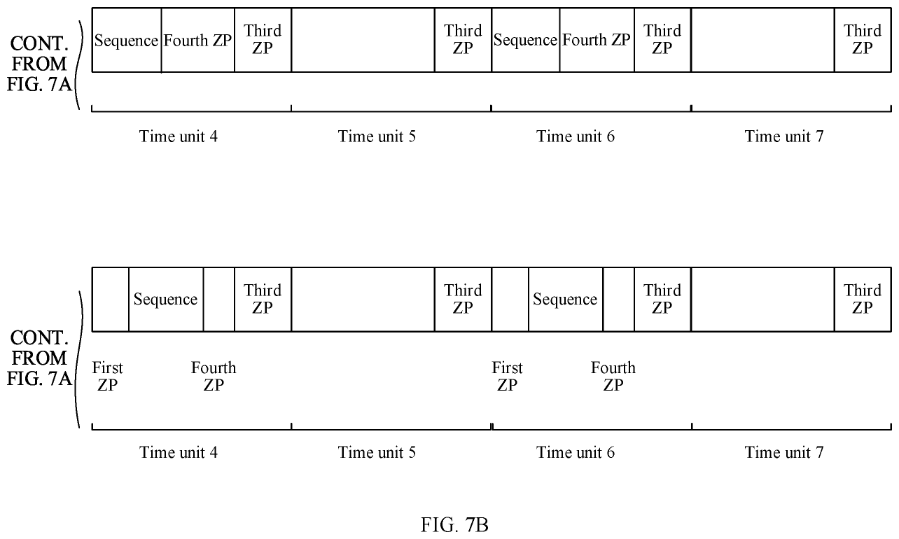

For example, one time unit includes Lᵤ single-carrier symbols, as shown in FIG. 7A and FIG. 7B. The quantity of time units is Nᵤ=7 in FIG. 7A and FIG. 7B, one sequence is sent in each of a 0^{th}, a 2^{nd}, a 4^{th}, and a 6^{th} time unit (N=4), the extension sequence is sₑₓₜ=[A, B, B, A], and four sequences correspondingly sent are x, y, y, and x. Data is sent in a₁^{st}, a 3^{rd}, and a 5^{th} time unit. The length of the first ZP includes two values: 0 and Lᵤ/4, and the sum of the length of the first ZP and the length of the fourth ZP is Lᵤ/2. It may be learned that for different lengths of the first ZP, duration of each time unit in which the sequence is sent remains the same.

It should be noted that the length of the first ZP being Lᵤ/4 in FIG. 7A and FIG. 7B may be understood as that a quantity of elements (that is, a quantity of digits 0) in the first ZP is Lᵤ/4.

One time unit being one SC-FDMA symbol is used as an example. Duration of the SC-FDMA symbol is Lᵤ Tₛ. In this case, a time domain signal sent in one time unit may be generated based on a sequence corresponding to the time unit.

When one sequence is sent in one time unit, Fourier transform may be performed on the sequence to generate frequency domain data, and then inverse Fourier transform is performed on the frequency domain data to obtain a time domain signal of the time unit. A quantity of points of the Fourier transform is the same as a length of the sequence. Duration of the time domain signal obtained based on inverse Fourier transform is LᵤTₛ or (Lᵤ−L_{1,zero}−L_{4,zero})Tₛ.

When one sequence is sent in one time unit, the first ZP may be added to the front of the sequence whose length is L_{seq}, that is, L_{1,zero} 0s are added to the front of the sequence; and the fourth ZP may be added to the end of the sequence whose length is L_{seq}, that is, L_{4,zero} 0s are added to the end of the sequence, to obtain an output result including L_{seq}+L_{1,zero}+L_{4,zero} values. Fourier transform is performed on the output result obtained with the first ZP and the fourth ZP added, to generate the frequency domain data, and then inverse Fourier transform is performed on the frequency domain data to obtain the time domain signal of the time unit.

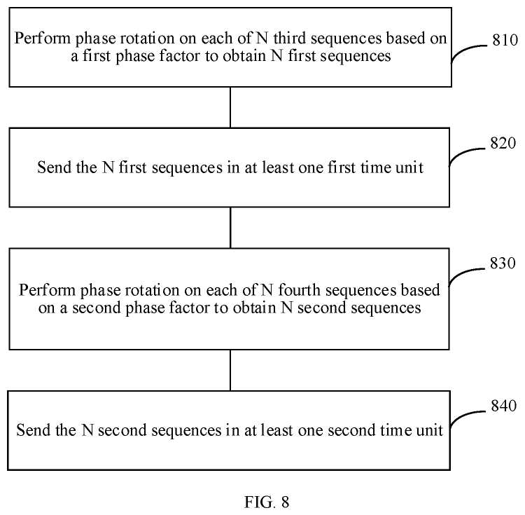

FIG. 8 is a block diagram of another sequence sending method according to this disclosure. As shown in FIG. 8, the method may include steps 810 to 840. The following describes steps 810 to 840 in detail.

Step 810: Perform phase rotation on each of N third sequences based on a first phase factor to obtain N first sequences.

For example, each of the N third sequences may be determined based on a GCP sequence, or may be determined based on another sequence. This is not specifically limited in this embodiment of this disclosure.

N is a positive integer greater than 1, the N third sequences are in one-to-one correspondence with the N first sequences, and a value of the first phase factor is related to the N third sequences.

Step 820: Send the N first sequences in at least one first time unit.

In this embodiment of this disclosure, the N first sequences may be sent in at least one first time unit. In one first time unit, one first sequence may be sent, or multiple first sequences may be sent. This is not specifically limited in this embodiment.

For example, steps 810 to 820 may be performed by a first communication apparatus.

Step 830: Perform phase rotation on each of N fourth sequences based on a second phase factor to obtain N second sequences.

For example, each of the N fourth sequences may be determined based on a GCP sequence, or may be determined based on another sequence. This is not specifically limited in this embodiment of this disclosure.

The N fourth sequences are in one-to-one correspondence with the N second sequences, a value of the second phase factor is related to the N fourth sequences, and the first phase factor is different from the second phase factor.

Step 840: Send the N second sequences in at least one second time unit.

In this embodiment of this disclosure, the N first sequences may be sent in at least one first time unit. In one first time unit, one first sequence may be sent, or multiple first sequences may be sent. This is not specifically limited in this embodiment.

For example, steps 830 to 840 may be performed by a second communication apparatus.

In the foregoing technical solution, for different requirement scenarios and requirements of a low ambiguity zone, different sequence sets may be designed to generate low ambiguity zones having different ranges (different sizes). For example, when a processing signal-to-noise ratio (SNR) loss is considered, a larger low ambiguity zone may be obtained by using a designed sequence set compared with a case with no SNR loss. When a maximum velocity (that is, a corresponding maximum Doppler) of target measurement is given, a larger range of the low ambiguity zone indicates that a larger quantity of phase rotation values can be supported. Therefore, a quantity of available phase rotation values may be determined based on different sequence sets.

Optionally, a phase value corresponding to an n^{th} sequence in the N first sequences is related to an index of a time unit in which the n^{th} sequence is located, and the phase value corresponding to the n^{th} sequence includes the first phase factor. Similarly, a phase value corresponding to a p^{th} sequence in the N second sequences is related to an index of a time unit in which the p^{th} sequence is located, and the phase value corresponding to the p^{th} sequence includes the second phase factor.

For example, the following provides descriptions using an example in which a first sending device sequentially sends N first sequences in Nᵤ time units.

For example, Nᵤ=N, and one first sequence is sent in each time unit. Indexes of the Nᵤ time units are from 0 to Nᵤ−1. In this case, a time unit n (an n^{th} time unit) corresponds to an n^{th} first sequence, and a phase value corresponding to the n^{th} first sequence is related to the index n.

Phase rotation is performed on each of the N third sequences. Specifically, a phase factor α (that is, the first phase factor) may be determined, an n^{th} third sequence of the N third sequences is multiplied by a phase value e^{jan}. For example, if the n^{th} third sequence of the N third sequences is represented as s, and the n^{th} first sequence obtained through phase rotation on the n^{th} third sequence is represented as s, the following is satisfied:

$${\tilde{s}}_{n} ( p ) = {s}_{n} ( p ) \times {e}^{j α n} , p = 0 , … , {L}_{seq} - 1$$

sₙ(p) represents a p^{th} element in the n^{th} third sequence, and \tilde{s}ₙ(p) represents a p^{th} element in the first sequence sₙ.

It should be understood that . . . above represents consecutive values between 0 and L_{seq}−1.

For example, a possible value of the phase factor α may be represented as a

$$α = 2 π \frac{i}{{N}_{phase}} or α = - 2 π \frac{i}{{N}_{phase}} .$$

Nₚₕₐₛₑ is a positive integer, and i may be referred to as a phase factor index. Possible values of i are some or all values in 0 to Nₚₕₐₛₑ−1. In other words, a set including the possible values of i is a subset of a set {0, 1, . . . , Nₚₕₐₛₑ−1}. It may be understood that a quantity of values of i determines a quantity of possible values of the phase factor α, and a maximum quantity of values of i is Nₚₕₐₛₑ. Therefore, Nₚₕₐₛₑ may be considered as a maximum quantity of values of the phase factor α.

Optionally, a possible value of the phase factor index i corresponds to an extension sequence, and a value of the parameter Nₚₕₐₛₑ corresponds to the extension sequence.

For phase rotation on each of the N fourth sequences, reference may be made to an implementation of phase rotation on each of the N third sequences.

For example, values of A and B are respectively 1 and −1, that is, a value of the extension sequence is 1 or −1.

For example, when the extension sequence is a repetition based on a sequence [1, −1], the quantity of possible values of the phase factor α is 1. In this case, Nₚₕₐₛₑ=1, and i∈{0}

For example, when the extension sequence is determined based on a Prouhet-Thue-Morse (Prouhet-Thue-Morse, PTM) sequence, the quantity of possible values of the phase factor α is 2. In this case, Nₚₕₐₛₑ=2, and i∈{0, 1}, or Nₚₕₐₛₑ=4, and i∈{1, 3}.

For example, it is assumed that an n^{th} value of the extension sequence is

$${\prod }_{m = 0}^{M - 1} {( {c}_{m} )}^{{b}_{m}} ,$$

bₘ satisfies

$$n = {\sum }_{m = 0}^{M - 1} ( {b}_{m} \times {\prod }_{i = - 1}^{m - 1} {a}_{i} ) ;$$

a₋₁=1, bₘ=0, 1, . . . , aₘ−1, cₘ is equal to 1 or −1, m=0, 1, . . . , M −1, and n=0, 1, . . . , N −1, where

$$N = {\prod }_{m = 0}^{M - 1} {a}_{m} ,$$

aₘ is a prime number, and M is a positive integer greater than 1. In this case, the quantity of possible values of the phase factor α is 3, where Nₚₕₐₛₑ=3, and i∈{0, 1, 2}, or Nₚₕₐₛₑ=6, and i∈{1, 3, 5}.

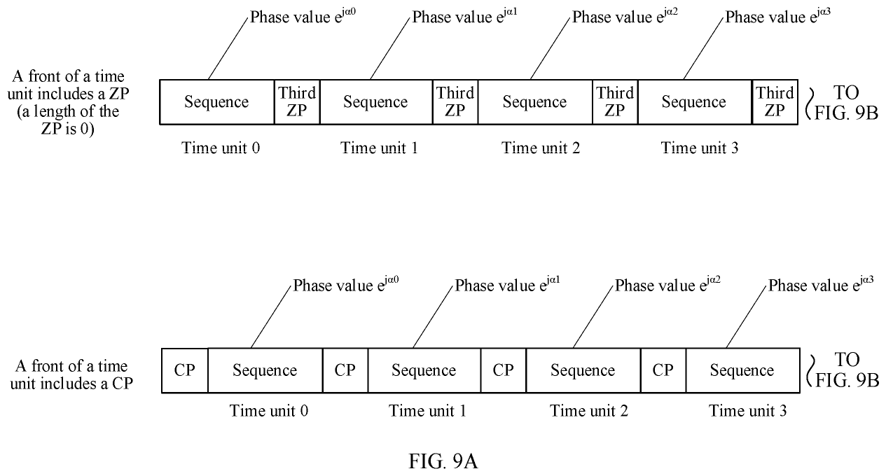

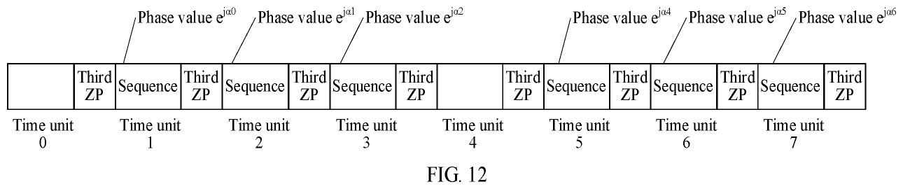

As shown in FIG. 9A and FIG. 9B, an extension sequence generated based on a PTM sequence is [1, −1, −1, 1, −1, 1, 1, −1], one time unit includes multiple single-carrier symbols, and sequences correspondingly sent in eight time units are x, y, y, x, y, x, x, and y respectively. When aperiodic correlation is considered, an end of the time unit may include a ZP (the third ZP). When periodic correlation is considered, a front of the time unit may include a cyclic prefix (CP). In this case, phase rotation is performed on a sequence sent in each time unit, and each time unit corresponds to one phase value. As shown in FIG. 9A and FIG. 9B, the time unit 0 to the time unit 8 respectively correspond to phase values e^{jα·0} to e^{jα·7}. With reference to FIG. 13A and FIG. 13B, the following describes in detail an embodiment in which a front of a time unit includes a CP.

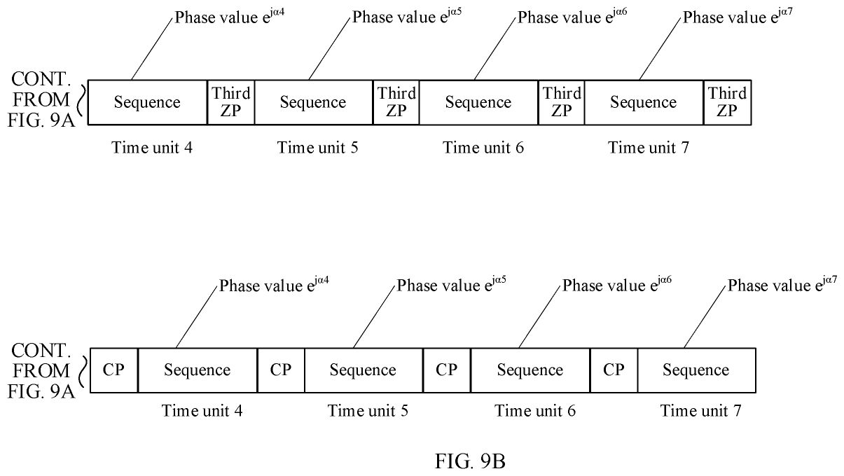

As shown in FIG. 10, time units for sending sequences are inconsecutive. There are eight time units in FIG. 10, and sequences correspondingly sent in four time units are x, y, y, and x respectively. A time unit 0 is a 0^{th} time unit in the four time units in which the sequences are sent, and corresponds to a phase value e^{jα·0}. A time unit 2 is a 1^{st} time unit in the four time units in which the sequences are sent, and corresponds to a phase value e^{jα·1}. A time unit 4 is a 2^{nd} time unit in the four time units in which the sequences are sent, and corresponds to a phase value e^{a}z. A time unit 6 is a 3^{rd} time unit in the four time units in which the sequences are sent, and corresponds to a phase value e^{jα·3}.

Optionally, the phase value corresponding to the n^{th} first sequence is related to an absolute index of the time unit in which the n^{th} first sequence is located. It may be understood that, in an actual communication system, numerous time units may be defined to transmit various types of reference signals or data, and an index of the defined time unit may be referred to as an absolute index.

For example, Nᵤ=N, and one sequence is sent in each time unit. In this case, the following is satisfied:

$${\tilde{s}}_{n} ( p ) = {s}_{n} ( p ) \times {e}^{j α \cdot I ( n )}$$

I(n) represents an absolute index of the n^{th} time unit in which the n^{th} sequence is located.

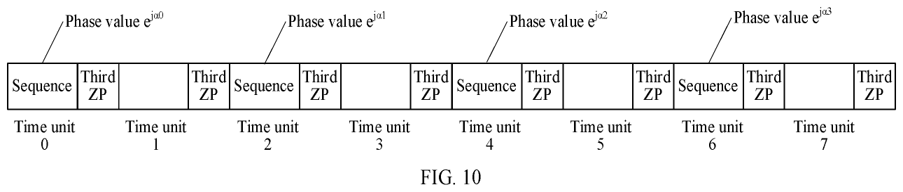

FIG. 11 is used as an example. In FIG. 11, it is assumed that eight time units are defined in a system, and sequences correspondingly sent in four time units are x, y, y, and x respectively. Absolute indexes of the four time units in which the sequences are sent are 0, 2, 4, and 6, that is, I=[0, 2, 4, 6], corresponding to phase values e^{jα·0}, e^{jα·2}, e^{jα·4}, and e^{jα·6} respectively.

Optionally, the phase value corresponding to the n^{th} first sequence is related to a distance between the absolute index of the time unit in which the n^{th} first sequence is located and an absolute index of a time unit in which a 0^{th} first sequence is located.

For example, Nᵤ=N, and one sequence is sent in each time unit. In this case, the following is satisfied:

$${\tilde{s}}_{n} ( p ) = {s}_{n} ( p ) \times {e}^{j α \cdot [ I ( n ) - I ( 0 ) ]} , or$$

$${\tilde{s}}_{n} ( p ) = {s}_{n} ( p ) \times {e}^{j α \cdot [ I ( n ) - I ( 0 ) ] / [ I ( 1 ) - I ( 0 ) ]}$$

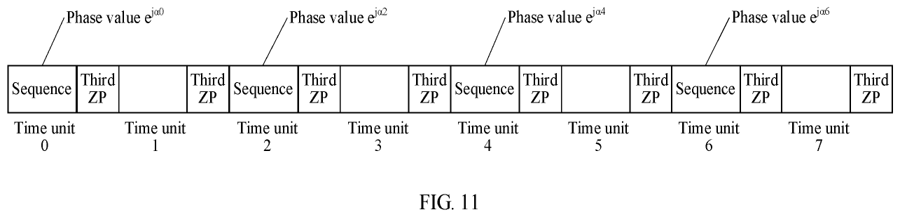

As shown in FIG. 12, \tilde{s}ₙ(p)=sₙ(p)×e^{jα·[I(n)-I(0)]/[I(1)-I(0)]} is used as an example. In FIG. 12, it is assumed that eight time units are defined in a system, sequences correspondingly sent in six time units are x, y, y, x, x, and y respectively, and absolute indexes of the six time units in which the sequences are sent are 1, 2, 3, 5, 6, and 7. Therefore, it may be learned that I=[1, 2, 3, 5, 6, 7], I(1) −I(0)=1, and phase values corresponding to the six time units are e^{jα·0}, e^{jα·1}, e^{jα·2}, e^{jα·4}, e^{jα·5}, and e^{jα·6} respectively.

In this embodiment of this disclosure, the time unit may further include a CP, and a value of the cyclic shift CP corresponds to the determined N sequences. In other words, cyclic shift may be performed on each to-be-sent sequence (a sequence before or after phase rotation). In this way, for different requirement scenarios and requirements of a low ambiguity zone, different sequence sets (the N sequences sent) may be designed to generate low ambiguity zones having different ranges (different sizes). For example, when a processing SNR loss is considered, a larger low ambiguity zone may be obtained by using a designed sequence set compared with a case with no SNR loss. When a maximum latency (that is, a corresponding maximum distance between a base station and a target) of target measurement is given, a larger range of the low ambiguity zone indicates that a larger quantity of cyclic shift values can be supported. Therefore, a quantity of available cyclic shift values may be determined based on the sequence set.

For example, the communication apparatus sequentially sends N sequences in Nᵤ time units, and a front of each time unit includes a cyclic prefix.

Cyclic shift is performed on each of the N sequences. Specifically, a cyclic shift value β_{cs} may be determined, and cyclic shift is performed on an n^{th} sequence of the N sequences based on the cyclic shift value β_{cs}. For example, if the n^{th} sequence of the N sequences is represented as sₙ, and the sequence obtained through cyclic shift on the n^{th} sequence is represented as ŝₙ, the following is satisfied:

$${\hat{s}}_{n} ( p ) = {s}_{n} [ ( p + {β}_{cs} ) mod {L}_{seq} ] , p = 0 , … , {L}_{seq} - 1$$

$$or$$

$${\hat{s}}_{n} ( p ) = {s}_{n} [ ( p - {β}_{cs} ) mod {L}_{seq} ] , p = 0 , … , {L}_{seq} - 1$$

The cyclic shift value β_{cs} may have one or more possible values, and a quantity of values of β_{cs} corresponds to the determined N sequences, that is, the quantity of values of β_{cs} corresponds to an extension sequence. The quantity of values of β_{cs} is represented as Nₑs, and all possible values of β_{cs} form a set

$${I}_{cs}^{group} .$$

The quantity N_{cs} of values of #_{cs} corresponds to the N sequences, and the set

$${I}_{cs}^{group}$$

corresponds to the N sequences.

Optionally, the quantity N_{cs} of values of β_{cs} corresponds to the extension sequence, and the set

$${I}_{cs}^{group}$$

corresponds to the extension sequence.

For example, when the extension sequence is a repetition based on a sequence [1, −1], the quantity of possible values of the cyclic shift value β_{cs} is N_{cs}=1, and

$${I}_{cs}^{group} = \{ 0 \} .$$

For example, when the extension sequence is determined based on a Prouhet-Thue-Morse (PTM) sequence, the quantity of possible values of the cyclic shift value β_{cs} is N_{cs}=2, and

$${I}_{cs}^{group} = \{ 0 , {L}_{seq} / 2 \} .$$

For example, Nᵤ=N, and one sequence is sent in each time unit. As shown in FIG. 13A and FIG. 13B, the cyclic shift value is 0 or L_{seq}/2.

It should be noted that, the cyclic shift value being 0 may also be referred to as a cyclic shift length being 0, and the cyclic shift value being L_{seq}/2 may also be referred to as a cyclic shift length being L_{seq}/2.

The foregoing mainly describes the solutions provided in this disclosure from the perspective of interaction between devices. Correspondingly, this disclosure further provides a communication apparatus, and the communication apparatus is configured to implement the foregoing methods. The communication apparatus may be the receive end apparatus in the foregoing method embodiments, or an apparatus including the receive end apparatus, or a component that can be used in the receive end apparatus.

It may be understood that, to implement the foregoing functions, the communication apparatus includes a hardware structure and/or a software module for performing a corresponding function. A person skilled in the art should easily be aware that, in combination with units and algorithm steps of the examples described in embodiments disclosed in this specification, this disclosure may be implemented by hardware or a combination of hardware and computer software. Whether a function is performed by hardware or hardware driven by computer software depends on particular applications and design constraints of the technical solutions. A person skilled in the art may use different methods to implement the described functions for each particular application, but it should not be considered that the implementation goes beyond the scope of this disclosure.

In embodiments of this disclosure, the communication apparatus may be divided into functional modules based on the foregoing method embodiments. For example, each functional module may be obtained through division based on each corresponding function, or two or more functions may be integrated into one processing module. The integrated module may be implemented in a form of hardware, or may be implemented in a form of a software functional module. It should be noted that, in embodiments of this disclosure, module division is an example, and is merely a logical function division. In actual implementation, another division manner may be used.

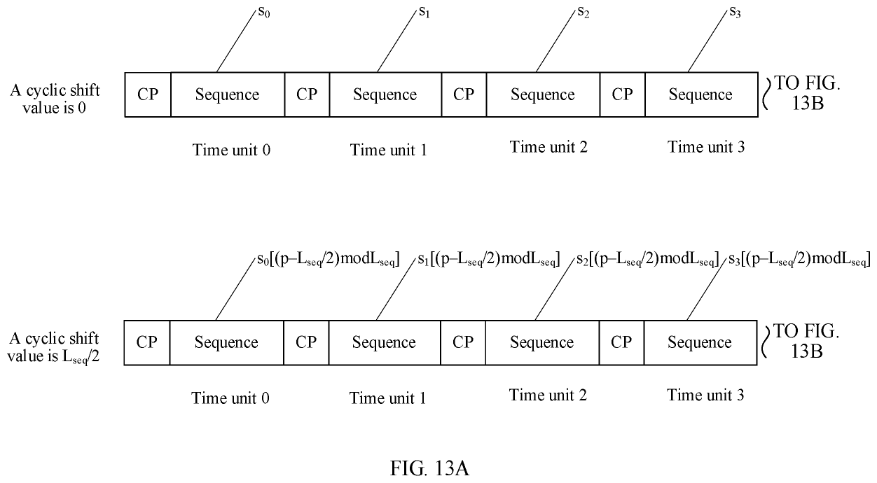

In an implementation scenario, the method provided above may be performed by one communication apparatus. FIG. 14 is a diagram of a structure of a communication apparatus 1400. The communication apparatus 1400 includes a processing module 1401 and a transceiver module 1402.

In some embodiments, the communication apparatus 1400 may further include a storage module, configured to store program instructions and data.

In some embodiments, the transceiver module 1402 may also be referred to as a transceiver unit, and is configured to implement a sending function and/or a receiving function. The transceiver module 1402 may include a transceiver circuit, a transceiver machine, a transceiver, or a communication interface.

In some embodiments, the transceiver module 1402 may include a receiving module and a sending module. The processing module 1401 may be configured to perform the processing (for example, determining or generation) steps in the foregoing method embodiments, and/or configured to support another process of the technology described in this specification.

In a possible implementation, the processing module 1401 is configured to determine a first zero padding and N first sequences, where N is a positive integer greater than 1, and the N first sequences are determined based on a GCP. The processing module 1401 is further configured to determine a second zero padding and N second sequences, where the N second sequences are determined based on a GCP, and a length of the first zero padding is different from a length of the second zero padding. The transceiver module 1402 is configured to send the N first sequences in at least one first time unit, where a front of a 1^{st} first time unit in the at least one first time unit includes the first zero padding. The transceiver module 1402 is further configured to send the N second sequences in at least one second time unit, where a front of a 1^{st} second time unit in the at least one second time unit includes the second zero padding.

Optionally, an end of each of the at least one first time unit includes a third zero padding, and the third zero padding is used to separate the at least one first time unit.

Optionally, an end of a last first time unit in the at least one first time unit includes a fourth zero padding, and a length of the fourth zero padding is related to the length of the first zero padding.

Optionally, a front of each of the at least one first time unit includes the first zero padding.

Optionally, an end of each of the at least one first time unit includes a fourth zero padding, and a length of the fourth zero padding is related to the length of the first zero padding.

Optionally, an end of each of the at least one second time unit includes a fifth zero padding, and the fifth zero padding is used to separate the at least one second time unit.

Optionally, an end of a last second time unit in the at least one second time unit includes a sixth zero padding, and a length of the sixth zero padding is related to the length of the second zero padding.

Optionally, a front of each of the at least one second time unit includes the second zero padding.

Optionally, an end of each of the at least one second time unit includes a sixth zero padding, and a length of the sixth zero padding is related to the length of the second zero padding.

Optionally, a sum of the length of the first zero padding and the length of the fourth zero padding is the same as a sum of the length of the second zero padding and the length of the sixth zero padding.

Optionally, the N first sequences are obtained by performing phase rotation on each of N third sequences based on a first phase factor, the N third sequences are in one-to-one correspondence with the N first sequences, a value of the first phase factor is related to the N third sequences, the N second sequences are obtained by performing phase rotation on each of N fourth sequences based on a second phase factor, the N fourth sequences are in one-to-one correspondence with the N second sequences, a value of the second phase factor is related to the N fourth sequences, the first phase factor is different from the second phase factor, the N third sequences are determined based on a GCP, and the N fourth sequences are determined based on a GCP.

Optionally, the processing module 1401 is further configured to perform phase rotation on each of N third sequences based on a first phase factor to obtain the N first sequences, where the N third sequences are in one-to-one correspondence with the N first sequences, and a value of the first phase factor is related to the N third sequences. The processing module 1401 is further configured to perform phase rotation on each of N fourth sequences based on a second phase factor to obtain the N second sequences, where the N fourth sequences are in one-to-one correspondence with the N second sequences, a value of the second phase factor is related to the N fourth sequences, and the first phase factor is different from the second phase factor.

Optionally, an n^{th} first sequence in the N first sequences is obtained by performing phase rotation on an n^{th} third sequence based on a phase value of the n^{th} third sequence, the phase value of the n^{th} third sequence is determined based on the first phase factor, and the phase value of the n^{th} third sequence is related to an index of a first time unit in which the n^{th} third sequence is located.

Optionally, the processing module 1401 is further configured to perform phase rotation on an n^{th} third sequence based on a phase value of the n^{th} third sequence to obtain an n^{th} first sequence in the N first sequences, where the phase value of the n^{th} third sequence is determined based on the first phase factor, and the phase value of the n^{th} third sequence is related to an index of a first time unit in which the n^{th} third sequence is located.

Optionally, each first time unit or second time unit includes at least one symbol, and the symbol includes any one of the following: a single-carrier symbol, an OFDM symbol, or an SC-FDMA symbol.

Optionally, each first time unit or second time unit includes at least one symbol, each symbol in the first time unit is generated based on at least one first sequence, and each symbol in the second time unit is generated based on at least one second sequence.

Optionally, at least one first sequence is sent in each of the at least one first time unit, and data of the at least one symbol included in each first time unit is generated based on the at least one first sequence corresponding to the first time unit.

Optionally, at least one second sequence is sent in each of the at least one second time unit, and data of the at least one symbol included in each second time unit is generated based on the at least one second sequence corresponding to the second time unit.

In another possible implementation, the processing module 1401 is configured to perform phase rotation on each of N third sequences based on a first phase factor to obtain N first sequences, where N is a positive integer greater than 1, the N third sequences are in one-to-one correspondence with the N first sequences, and a value of the first phase factor is related to the N third sequences. The processing module 1401 is further configured to perform phase rotation on each of N fourth sequences based on a second phase factor to obtain N second sequences, where the N fourth sequences are in one-to-one correspondence with the N second sequences, a value of the second phase factor is related to the N fourth sequences, and the first phase factor is different from the second phase factor. The transceiver module 1402 is configured to send the N first sequences in at least one first time unit. The transceiver module 1402 is further configured to send the N second sequences in at least one second time unit, where the N third sequences are determined based on a GCP, and the N fourth sequences are determined based on a GCP.

Optionally, an n^{th} first sequence in the N first sequences is obtained by performing phase rotation on an n^{th} third sequence based on a phase value of the n^{th} third sequence, the phase value of the n^{th} third sequence is determined based on the first phase factor, and the phase value of the n^{th} third sequence is related to an index of a first time unit in which the n^{th} third sequence is located.

Optionally, the processing module 1401 is further configured to perform phase rotation on an n^{th} third sequence based on a phase value of the n^{th} third sequence to obtain an n^{th} first sequence in the N first sequences, where the phase value of the n^{th} third sequence is determined based on the first phase factor, and the phase value of the n^{th} third sequence is related to an index of a first time unit in which the n^{th} third sequence is located.

Optionally, a front of a 1^{st} first time unit in the at least one first time unit includes a first zero padding.

Optionally, an end of each of the at least one first time unit includes a third zero padding, and the third zero padding is used to separate the at least one first time unit.

Optionally, an end of a last first time unit in the at least one first time unit includes a fourth zero padding, and a length of the fourth zero padding is related to a length of the first zero padding.

Optionally, a front of each of the at least one first time unit includes the first zero padding.

Optionally, an end of each of the at least one first time unit includes a fourth zero padding, and a length of the fourth zero padding is related to a length of the first zero padding.

Optionally, a front of a 1^{st} second time unit in the at least one second time unit includes a second zero padding, and a length of the second zero padding is different from the length of the first zero padding.

Optionally, an end of each of the at least one second time unit includes a fifth zero padding, and the fifth zero padding is used to separate the at least one second time unit.

Optionally, an end of a last second time unit in the at least one second time unit includes a sixth zero padding, and a length of the sixth zero padding is related to the length of the second zero padding.

Optionally, a front of each of the at least one second time unit includes the second zero padding.

Optionally, an end of each of the at least one second time unit includes a sixth zero padding, and a length of the sixth zero padding is related to the length of the second zero padding.

Optionally, a front of each of the at least one first time unit includes a first cyclic prefix, and each of the at least one second time unit includes a second cyclic prefix.

Optionally, each of the N first sequences is obtained by performing cyclic shift on each of N fifth sequences based on a value of a first cyclic shift, the value of the first cyclic shift is related to the N fifth sequences, the N second sequences are obtained by performing cyclic shift on each of N sixth sequences based on a value of a second cyclic shift, the value of the second cyclic shift is related to the N sixth sequences, and the value of the second cyclic shift is different from the value of the first cyclic shift.

Optionally, the processing module 1401 is further configured to perform cyclic shift on each of N fifth sequences based on a value of a first cyclic shift to obtain the N first sequences, where the value of the first cyclic shift is related to the N fifth sequences, and perform cyclic shift on each of N sixth sequences based on a value of a second cyclic shift to obtain the N second sequences, where the value of the second cyclic shift is related to the N sixth sequences, and the value of the second cyclic shift is different from the value of the first cyclic shift.

Optionally, each first time unit or second time unit includes at least one symbol, and the symbol includes any one of the following: a single-carrier symbol, an OFDM symbol, or an SC-FDMA symbol.

Optionally, each first time unit or second time unit includes at least one symbol, each symbol in the first time unit is generated based on at least one first sequence, and each symbol in the second time unit is generated based on at least one second sequence.

Optionally, at least one first sequence is sent in each of the at least one first time unit, and data of the at least one symbol included in each first time unit is generated based on the at least one first sequence corresponding to the first time unit.

Optionally, at least one second sequence is sent in each of the at least one second time unit, and data of the at least one symbol included in each second time unit is generated based on the at least one second sequence corresponding to the second time unit.

In this disclosure, the communication apparatus 1400 is presented with functional modules obtained through division in an integrated manner. The module herein may be an ASIC, a circuit, a processor that executes one or more software or firmware programs, a memory, an integrated logic circuit, and/or another component capable of providing the foregoing functions.

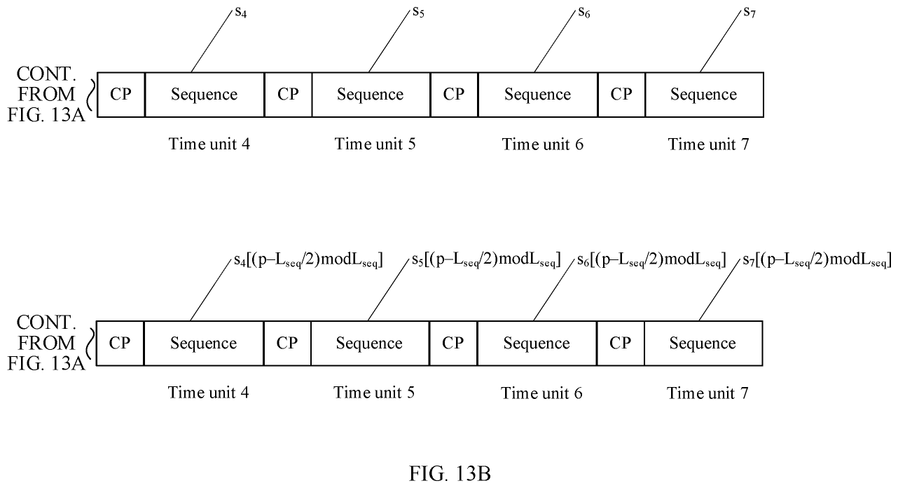

In another implementation scenario, the method provided above may be performed by at least two communication apparatuses. FIG. 15 is a diagram of a communication system. The communication system may include a first communication apparatus 1500 and a second communication apparatus 1600. The first communication apparatus 1500 includes a first processing module 1501 and a first transceiver module 1502, and the second communication apparatus 1600 includes a second processing module 1601 and a second transceiver module 1602.

In some embodiments, the first communication apparatus 1500 and the second communication apparatus 1600 may further include a storage module, configured to store program instructions and data.

In a possible implementation, the first processing module 1501 is configured to determine a first zero padding and N first sequences, where N is a positive integer greater than 1, and the N first sequences are determined based on a GCP. The second processing module 1601 is further configured to determine a second zero padding and N second sequences, where the N second sequences are determined based on a GCP, and a length of the first zero padding is different from a length of the second zero padding. The first transceiver module 1502 is configured to send the N first sequences in at least one first time unit, where a front of a 1^{st} first time unit in the at least one first time unit includes the first zero padding. The second transceiver module 1602 is configured to send the N second sequences in at least one second time unit, where a front of a 1^{st} second time unit in the at least one second time unit includes the second zero padding.

Optionally, an end of each of the at least one first time unit includes a third zero padding, and the third zero padding is used to separate the at least one first time unit.

Optionally, an end of a last first time unit in the at least one first time unit includes a fourth zero padding, and a length of the fourth zero padding is related to the length of the first zero padding.

Optionally, a front of each of the at least one first time unit includes the first zero padding.

Optionally, an end of each of the at least one first time unit includes a fourth zero padding, and a length of the fourth zero padding is related to the length of the first zero padding.

Optionally, an end of each of the at least one second time unit includes a fifth zero padding, and the fifth zero padding is used to separate the at least one second time unit.

Optionally, an end of a last second time unit in the at least one second time unit includes a sixth zero padding, and a length of the sixth zero padding is related to the length of the second zero padding.

Optionally, a front of each of the at least one second time unit includes the second zero padding.

Optionally, an end of each of the at least one second time unit includes a sixth zero padding, and a length of the sixth zero padding is related to the length of the second zero padding.

Optionally, a sum of the length of the first zero padding and the length of the fourth zero padding is the same as a sum of the length of the second zero padding and the length of the sixth zero padding.

Optionally, the N first sequences are obtained by performing phase rotation on each of N third sequences based on a first phase factor, the N third sequences are in one-to-one correspondence with the N first sequences, a value of the first phase factor is related to the N third sequences, the N second sequences are obtained by performing phase rotation on each of N fourth sequences based on a second phase factor, the N fourth sequences are in one-to-one correspondence with the N second sequences, a value of the second phase factor is related to the N fourth sequences, the first phase factor is different from the second phase factor, the N third sequences are determined based on a GCP, and the N fourth sequences are determined based on a GCP.

Optionally, the first processing module 1501 is further configured to perform phase rotation on each of N third sequences based on a first phase factor to obtain the N first sequences, where the N third sequences are in one-to-one correspondence with the N first sequences, and a value of the first phase factor is related to the N third sequences. The second processing module 1601 is further configured to perform phase rotation on each of N fourth sequences based on a second phase factor to obtain the N second sequences, where the N fourth sequences are in one-to-one correspondence with the N second sequences, a value of the second phase factor is related to the N fourth sequences, and the first phase factor is different from the second phase factor.

Optionally, an n^{th} first sequence in the N first sequences is obtained by performing phase rotation on an n^{th} third sequence based on a phase value of the n^{th} third sequence, the phase value of the n^{th} third sequence is determined based on the first phase factor, and the phase value of the n^{th} third sequence is related to an index of a first time unit in which the n^{th} third sequence is located.

Optionally, the first processing module 1501 is further configured to perform phase rotation on an n^{th} third sequence based on a phase value of the n^{th} third sequence to obtain an n^{th} first sequence in the N first sequences, where the phase value of the n^{th} third sequence is determined based on the first phase factor, and the phase value of the n^{th} third sequence is related to an index of a first time unit in which the n^{th} third sequence is located.

Optionally, each first time unit or second time unit includes at least one symbol, and the symbol includes any one of the following: a single-carrier symbol, an OFDM symbol, or an SC-FDMA symbol.

Optionally, each first time unit or second time unit includes at least one symbol, each symbol in the first time unit is generated based on at least one first sequence, and each symbol in the second time unit is generated based on at least one second sequence.

Optionally, at least one first sequence is sent in each of the at least one first time unit, and data of the at least one symbol included in each first time unit is generated based on the at least one first sequence corresponding to the first time unit.

Optionally, at least one second sequence is sent in each of the at least one second time unit, and data of the at least one symbol included in each second time unit is generated based on the at least one second sequence corresponding to the second time unit.

In another possible implementation, the first processing module 1501 is configured to perform phase rotation on each of N third sequences based on a first phase factor to obtain N first sequences, where N is a positive integer greater than 1, the N third sequences are in one-to-one correspondence with the N first sequences, and a value of the first phase factor is related to the N third sequences. The second processing module 1601 is further configured to perform phase rotation on each of N fourth sequences based on a second phase factor to obtain N second sequences, where the N fourth sequences are in one-to-one correspondence with the N second sequences, a value of the second phase factor is related to the N fourth sequences, and the first phase factor is different from the second phase factor. The first transceiver module 1502 is configured to send the N first sequences in at least one first time unit. The second transceiver module 1602 is configured to send the N second sequences in at least one second time unit, where the N third sequences are determined based on a GCP, and the N fourth sequences are determined based on a GCP.

Optionally, an n^{th} first sequence in the N first sequences is obtained by performing phase rotation on an n^{th} third sequence based on a phase value of the n^{th} third sequence, the phase value of the n^{th} third sequence is determined based on the first phase factor, and the phase value of the n^{th} third sequence is related to an index of a first time unit in which the n^{th} third sequence is located.

Optionally, the first processing module 1501 is further configured to perform phase rotation on an n^{th} third sequence based on a phase value of the n^{th} third sequence to obtain an n^{th} first sequence in the N first sequences, where the phase value of the n^{th} third sequence is determined based on the first phase factor, and the phase value of the n^{th} third sequence is related to an index of a first time unit in which the n^{th} third sequence is located.

Optionally, a front of a 1^{st} first time unit in the at least one first time unit includes a first zero padding.

Optionally, an end of each of the at least one first time unit includes a third zero padding, and the third zero padding is used to separate the at least one first time unit.

Optionally, an end of a last first time unit in the at least one first time unit includes a fourth zero padding, and a length of the fourth zero padding is related to a length of the first zero padding.

Optionally, a front of each of the at least one first time unit includes the first zero padding.

Optionally, an end of each of the at least one first time unit includes a fourth zero padding, and a length of the fourth zero padding is related to a length of the first zero padding.

Optionally, a front of a 1^{st} second time unit in the at least one second time unit includes a second zero padding, and a length of the second zero padding is different from the length of the first zero padding.

Optionally, an end of each of the at least one second time unit includes a fifth zero padding, and the fifth zero padding is used to separate the at least one second time unit.

Optionally, an end of a last second time unit in the at least one second time unit includes a sixth zero padding, and a length of the sixth zero padding is related to the length of the second zero padding.

Optionally, a front of each of the at least one second time unit includes the second zero padding.

Optionally, an end of each of the at least one second time unit includes a sixth zero padding, and a length of the sixth zero padding is related to the length of the second zero padding.

Optionally, a front of each of the at least one first time unit includes a first cyclic prefix, and each of the at least one second time unit includes a second cyclic prefix.

Optionally, each of the N first sequences is obtained by performing cyclic shift on each of N fifth sequences based on a value of a first cyclic shift, the value of the first cyclic shift is related to the N fifth sequences, the N second sequences are obtained by performing cyclic shift on each of N sixth sequences based on a value of a second cyclic shift, the value of the second cyclic shift is related to the N sixth sequences, and the value of the second cyclic shift is different from the value of the first cyclic shift.

Optionally, the first processing module 1501 is further configured to perform cyclic shift on each of N fifth sequences based on a value of a first cyclic shift to obtain the N first sequences, where the value of the first cyclic shift is related to the N fifth sequences, and perform cyclic shift on each of N sixth sequences based on a value of a second cyclic shift to obtain the N second sequences, where the value of the second cyclic shift is related to the N sixth sequences, and the value of the second cyclic shift is different from the value of the first cyclic shift.

Optionally, each first time unit or second time unit includes at least one symbol, and the symbol includes any one of the following: a single-carrier symbol, an OFDM symbol, or an SC-FDMA symbol.

Optionally, each first time unit or second time unit includes at least one symbol, each symbol in the first time unit is generated based on at least one first sequence, and each symbol in the second time unit is generated based on at least one second sequence.

Optionally, at least one first sequence is sent in each of the at least one first time unit, and data of the at least one symbol included in each first time unit is generated based on the at least one first sequence corresponding to the first time unit.

Optionally, at least one second sequence is sent in each of the at least one second time unit, and data of the at least one symbol included in each second time unit is generated based on the at least one second sequence corresponding to the second time unit.

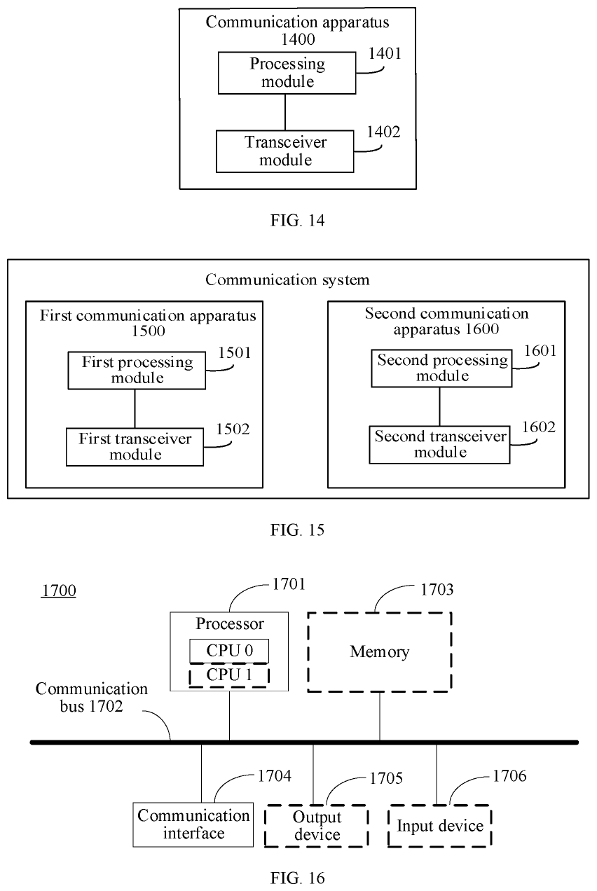

In some embodiments, in hardware implementation, a person skilled in the art may figure out that the communication apparatus 1400 may be in a form of a communication device 1700 shown in FIG. 16.

Refer to FIG. 16. The communication device 1700 includes one or more processors 1701. Further, the communication device 1700 may further include a communication bus 1702 and at least one communication interface (FIG. 16 is merely an example, and an example in which the communication device 1700 includes a communication interface 1704 and one processor 1701 is used for description). Optionally, the communication device 1700 may further include a memory 1703.

The processor 1701 may be a general-purpose central processing unit (CPU), a microprocessor, an application-specific integrated circuit (ASIC), one or more integrated circuits configured to control program execution in the solutions of this disclosure, or a processing core configured to process data (for example, computer program instructions). The processor may be a single-core (single-CPU) processor, or may be a multi-core (multi-CPU) processor.

During specific implementation, in an embodiment, the processor 1701 may include one or more CPUs, for example, a CPU 0 and a CPU 1 in FIG. 16.

The communication bus 1702 may be a Peripheral Component Interconnect (PCI) bus, an Extended Industry Standard Architecture (EISA) bus, or the like. The bus may be classified into an address bus, a data bus, a control bus, and the like. For ease of representation, only one bold line is used for representation in FIG. 16, but this does not mean that there is only one bus or only one type of bus. The communication bus 1702 is configured to connect different components in the communication device 1700, so that different components in the communication device 1700 may communicate and interact with each other.

The communication interface 1704 may be a transceiver module, and is configured to communicate with another device or a communication network. The communication network may be, for example, an Ethernet, a RAN, or a WLAN. For example, the communication interface 1704 may be an apparatus such as a transceiver or a transceiver machine. Alternatively, the communication interface 1704 may be a transceiver circuit located in the processor 1701, to implement signal input and signal output of the processor.

The memory 1703 may be an apparatus having a storage function. For example, the memory 1703 may be a read-only memory (ROM) or another type of static storage device capable of storing static information and instructions, or a random-access memory (RAM) or another type of dynamic storage device capable of storing information and instructions, or may be an electrically erasable programmable read-only memory (EEPROM), a compact disc read-only memory (CD-ROM) or other compact disc storage, optical disc storage (including a compact disc, a laser disc, an optical disc, a digital versatile disc, a Blu-ray disc, or the like), a magnetic disk storage medium or another magnetic storage device, or any other medium capable of carrying or storing expected program code in a form of instruction or data structure and capable of being accessed by a computer. This is not limited thereto. The memory may exist independently, and is connected to the processor through the communication bus 1702. The memory may alternatively be integrated with the processor.

For example, the memory 1703 is configured to store computer-executable instructions for executing the solutions of this disclosure, and the processor 1701 controls the execution. The processor 1701 is configured to execute the computer-executable instructions stored in the memory 1703, to implement the method provided in embodiments of this disclosure.

Alternatively, optionally, in embodiments of this disclosure, the processor 1701 may perform functions related to processing in the method provided in embodiments in this disclosure, and the communication interface 1704 is responsible for communication with another device or a communication network. This is not specifically limited in embodiments of this disclosure.

Optionally, the computer-executable instructions in this embodiment of this disclosure may also be referred to as application program code. This is not specifically limited in this embodiment of this disclosure.

In a specific implementation, in an embodiment, the communication device 1700 may further include an output device 1705 and an input device 1706. The output device 1705 communicates with the processor 1701, and may display information in multiple manners. For example, the output device 1705 may be a liquid-crystal display (LCD), a light-emitting diode (LED) display device, a cathode-ray tube (CRT) display device, a projector, or the like. The input device 1706 communicates with the processor 1701, and may receive a user input in multiple manners. For example, the input device 1706 may be a mouse, a keyboard, a touchscreen device, or a sensor device.

It should be noted that, the composition structure shown in FIG. 16 constitutes no limitation on the communication device. In addition to the components shown in FIG. 16, the communication device may include more or fewer components than those shown in the figure, combine some components, or have different component arrangements.

As a possible product form, the communication device in embodiments of this disclosure may alternatively be implemented by using the following: one or more field-programmable gate arrays (FPGA), a programmable logic device (PLD), a controller, a state machine, gate logic, and a discrete hardware component, any other proper circuit, or any combination of circuits that can perform various functions described throughout this disclosure.

In some embodiments, if the method provided above is performed by at least two communication apparatuses in FIG. 15, each of the at least two communication apparatuses may use the form of the communication device 1700 shown in FIG. 16. For example, the method provided above is performed by the first communication apparatus 1500 and the second communication apparatus 1600 included in the communication system shown in FIG. 15. Both the first communication apparatus 1500 and the second communication apparatus 1600 may use the form of the communication device 1700 shown in FIG. 16.

This disclosure further provides a computer-readable storage medium. The computer-readable storage medium stores a computer program or instructions. When the computer program or instructions are executed by a computer, functions in any foregoing method embodiment are implemented.

This disclosure further provides a computer program product. When the computer program product is executed by a computer, functions of any one of the foregoing method embodiments are implemented.

A person of ordinary skill in the art may understand that, for the purpose of convenient and brief description, for a detailed working process of the foregoing system, apparatuses, and units, refer to a corresponding process in the foregoing method embodiment. Details are not described herein again.

It may be understood that the system, apparatuses, and methods described in this disclosure may alternatively be implemented in another manner. For example, the described apparatus embodiments are merely examples. For example, division into the units is merely logical function division and may be other division during actual implementation. For example, multiple units or components may be combined or integrated into another system, or some features may be ignored or not performed. In addition, the displayed or discussed mutual couplings or direct couplings or communication connections may be implemented by using some interfaces. The indirect couplings or communication connections between the apparatuses or units may be implemented in electric, mechanical, or other forms.

The units described as separate parts may be physically separated or not, this is, may be located together in a same place or distributed on multiple network units. Parts displayed as units may be or may be not physical units. Some or all of the units may be selected based on actual requirements to achieve the objectives of the solutions of embodiments.

In addition, functional units in embodiments of this disclosure may be integrated into one processing unit, or each of the units may exist alone physically, or two or more units may be integrated into one unit.

All or some of the foregoing embodiments may be implemented by using software, hardware, firmware, or any combination thereof. When a software program is used to implement embodiments, embodiments may be implemented completely or partially in a form of a computer program product. The computer program product includes one or more computer instructions. When the computer program instructions are loaded and executed on a computer, all or some of procedures (or functions) described in embodiments of this disclosure are implemented. The computer may be a general-purpose computer, a dedicated computer, a computer network, or other programmable apparatuses. The computer instructions may be stored in a computer-readable storage medium or may be transmitted from a computer-readable storage medium to another computer-readable storage medium. For example, the computer instructions may be transmitted from a website, computer, server, or data center to another website, computer, server, or data center in a wired (for example, a coaxial cable, an optical fiber, or a digital subscriber line (DSL)) or wireless (for example, infrared, radio, or microwave) manner. The computer-readable storage medium may be any usable medium accessible by a computer, or a data storage device, such as a server or a data center, integrating one or more usable media. The usable medium may be a magnetic medium (for example, a floppy disk, a hard disk drive, or a magnetic tape), an optical medium (for example, a digital versatile disc (DVD)), a semiconductor medium (for example, a solid-state drive (SSD)), or the like. In embodiments of this disclosure, the computer may include the foregoing apparatuses.

Although this disclosure is described with reference to embodiments, in a process of implementing this disclosure that claims protection, a person skilled in the art may understand and implement another variation of the disclosed embodiments by viewing the accompanying drawings, disclosed content, and appended claims. In the claims, “comprising” does not exclude another component or another step, and “a” or “one” does not exclude a case of multiple. A single processor or another unit may implement several functions enumerated in the claims. Some measures are recorded in dependent claims that are different from each other, but this does not mean that these measures cannot be combined to produce a better effect.

Although this disclosure is described with reference to specific features and embodiments thereof, it is clear that various modifications and combinations may be made to them without departing from the spirit and scope of this disclosure. Correspondingly, the specification and accompanying drawings are merely example description of this disclosure defined by the appended claims, and are considered to have covered any of or all modifications, variations, combinations or equivalents within the scope of this disclosure. It is clear that a person skilled in the art can make various modifications and variations to this disclosure without departing from the spirit and scope of this disclosure. This disclosure is intended to cover these modifications and variations of this disclosure provided that they fall within the scope of the claims of this disclosure and their equivalent technologies.

1. A method, comprising:
determining a first zero padding and N first sequences, wherein the first zero padding has a first length, wherein N is a positive integer greater than 1, and wherein the N first sequences are based on a first Golay complementary pair (GCP);
sending the N first sequences in at least one first time unit, wherein a first front of one of the at least one first time unit comprises the first zero padding;
determining a second zero padding and N second sequences, wherein the second zero padding has a second length, wherein the N second sequences are based on a second GCP, and wherein the first length is different from the second length; and
sending the N second sequences in at least one second time unit, wherein a second front of one of the at least one second time unit comprises the second zero padding.

2. The method according to claim 1, wherein an end of each of the at least one first time unit comprises a third zero padding, and wherein the third zero padding is configured to separate the at least one first time unit from a different time unit.

3. The method according to claim 1, wherein an end of a last first time unit in the at least one first time unit comprises a third zero padding, and wherein the third zero padding has a third length that is related to the first length.

4. The method according to claim 1, wherein a front of each of the at least one first time unit comprises the first zero padding, wherein an end of each of the at least one first time unit comprises a third zero padding, and wherein the third zero padding has a third length that is related to the first length.

5. The method according to claim 1, wherein at least one of the following is satisfied:
an end of each of the at least one second time unit comprises a third zero padding, wherein the third zero padding is configured to separate the at least one second time unit from a different time unit;
an end of a last second time unit in the at least one second time unit comprises a fourth zero padding, wherein the fourth zero padding has a third length that is related to the second length;
a front of each of the at least one second time unit comprises the second zero padding; or
an end of each of the at least one second time unit comprises the fourth zero padding, wherein the third length is related to the second length.

6. The method according to claim 1, further comprising:
performing, based on a first phase factor, phase rotation on each of N third sequences to obtain the N first sequence, wherein the N third sequences are in one-to-one correspondence with the N first sequences, and wherein a first value of the first phase factor is related to the N third sequences; and
performing, based on a second phase factor, phase rotation on each of N fourth sequences to obtain the N second sequences, wherein the N fourth sequences are in one-to-one correspondence with the N second sequences, wherein a second value of the second phase factor is related to the N fourth sequences, wherein the first phase factor is different from the second phase factor, and wherein the N third sequences and the N fourth sequences are based on a third GCP.

7. The method according to claim 6, further comprising performing, based on a phase value of an n^{th} third sequence, phase rotation on the n^{th} third sequence to obtain an n^{th} first sequence in the N first sequence, wherein the phase value of the n^{th} third sequence is based on the first phase factor, and wherein the phase value of the n^{th} third sequence is related to an index of a first time unit in which the n^{th} third sequence is located.

8. An apparatus, comprising:
a non-transitory computer-readable medium configured to store instructions; and
at least one processor configured to execute the instructions to cause the apparatus to:
determine a first zero padding and N first sequences, wherein the first zero padding has a first length, wherein N is a positive integer greater than 1, and wherein the N first sequences are based on a first Golay complementary pair (GCP);
send the N first sequences in at least one first time unit, wherein a first front of one of the at least one first time unit comprises the first zero padding;
determine a second zero padding and N second sequences, wherein the second zero padding has a second length, wherein the N second sequences are based on a second GCP, and wherein the first length is different from the second length; and
send the N second sequences in at least one second time unit, wherein a second front of one of the at least one second time unit comprises the second zero padding.

9. The apparatus according to claim 8, wherein an end of each of the at least one first time unit comprises a third zero padding, and wherein the third zero padding is configured to separate the at least one first time unit from a different time unit.

10. The apparatus according to claim 8, wherein an end of a last first time unit in the at least one first time unit comprises a third zero padding, and wherein the third zero padding has a third length that is related to the first length.

11. The apparatus according to claim 8, wherein a front of each of the at least one first time unit comprises the first zero padding, wherein an end of each of the at least one first time unit comprises a third zero padding, and wherein the third zero padding has a third length that is related to the first length.

12. The apparatus according to claim 8, wherein at least one of the following is satisfied:
an end of each of the at least one second time unit comprises a third zero padding, wherein the third zero padding is configured to separate the at least one second time unit from a different time unit;
an end of a last second time unit in the at least one second time unit comprises a fourth zero padding, wherein the fourth zero padding has a third length that is related to the second length;
a front of each of the at least one second time unit comprises the second zero padding; or
an end of each of the at least one second time unit comprises the fourth zero padding, wherein the third length is related to the second length.

13. The apparatus according to claim 8, wherein the at least one processor is further configured to execute the instructions to cause the apparatus to:
perform, based on a first phase factor, phase rotation on each of N third sequences to obtain the N first sequences, wherein the N third sequences are in one-to-one correspondence with the N first sequences, and wherein a first value of the first phase factor is related to the N third sequences; and
perform, based on a second phase factor, phase rotation on each of N fourth sequences to obtain the N second sequences, wherein the N fourth sequences are in one-to-one correspondence with the N second sequences, wherein a second value of the second phase factor is related to the N fourth sequences, wherein the first phase factor is different from the second phase factor, and wherein the N third sequences and the N fourth sequences are based on a third GCP.

14. The apparatus according to claim 13, wherein the at least one processor is further configured to execute the instructions to cause the apparatus to perform, based on a phase value of an n^{th} third sequence, phase rotation on the n^{th} third sequence to obtain an n^{th} first sequence in the N first sequences, wherein the phase value of the n^{th} third sequence is determined-based on the first phase factor, and wherein the phase value of the n^{th} third sequence is related to an index of a first time unit in which the n^{th} third sequence is located.

15. An apparatus, comprising:
a non-transitory computer-readable medium configured to store instructions, and
at least one processor configured to execute the instructions to cause the apparatus to:
perform, based on a first phase factor, phase rotation on each of N third sequences to obtain N first sequences, wherein N is a positive integer greater than 1, wherein the N third sequences are in one-to-one correspondence with the N first sequences, wherein a first value of the first phase factor is related to the N third sequences, and wherein the N third sequences are based on a first Golay complementary pair (GCP);
send the N first sequences in at least one first time unit;
perform, based on a second phase factor, phase rotation on each of N fourth sequences to obtain N second sequences, wherein the N fourth sequences are in one-to-one correspondence with the N second sequences, wherein a second value of the second phase factor is related to the N fourth sequences, wherein the first phase factor is different from the second phase factor, and wherein the N fourth sequences are based on a second GCP; and
send the N second sequences in at least one second time unit.

16. The apparatus according to claim 15, wherein the at least one processor is further configured to execute the instructions to cause the apparatus to perform, based on a phase value of an n^{th} third sequence, phase rotation on the n^{th} third sequence to obtain an n^{th} first sequence in the N first sequences, wherein the phase value is based on the first phase factor, and wherein the phase value is related to an index of a first time unit in which the n^{th} third sequence is located.

17. The apparatus according to claim 15, wherein a front of one of the at least one first time unit comprises a first zero padding, wherein an end of each of the at least one first time unit comprises a second zero padding, and wherein the second zero padding is configured to separate the at least one first time unit from a different time unit.

18. The apparatus according to claim 15, wherein at least one of the following is satisfied:
an end of a last first time unit in the at least one first time unit comprises a second zero padding, wherein the second zero padding has a second length that is related to a first length of a first zero padding;
a front of each of the at least one first time unit comprises the first zero padding; or
an end of each of the at least one first time unit comprises the second zero padding, wherein the second length is related to the first length.

19. The apparatus according to claim 15, wherein at least one of the following is satisfied:
a first front of one of the at least one second time unit comprises a second zero padding, wherein the second zero padding has a second length that is different from a first length of a first zero padding;
an end of each of the at least one second time unit comprises a third zero padding, wherein the third zero padding is configured to separate the at least one second time unit from a different time unit;
an end of a last second time unit in the at least one second time unit comprises a fourth zero padding, wherein the fourth zero padding has a third length that is related to the second length;
a front of each of the at least one second time unit comprises the second zero padding; or
an end of each of the at least one second time unit comprises the fourth zero padding, wherein the third length is related to the second length.

20. The apparatus according to claim 15, wherein a front of each of the at least one first time unit comprises a first cyclic prefix, wherein each of the at least one second time unit comprises a second cyclic prefix, and wherein the at least one processor is further configured to execute the instructions to cause the apparatus to:
perform, based on a third value of a first cyclic shaft, a cyclic shift on each of N fifth sequences to obtain each of the N first sequences, wherein the third value is related to the N fifth sequences; and
perform, based on a fourth value of a second cyclic shift, a cyclic shift on each of N sixth sequences to obtain the N second sequences, wherein the fourth value is related to the N sixth sequences, and wherein the fourth value is different from the third value.
